(19) United States
(12) Patent Application Publication
(10) Pub. No.: US 2023/0318932 A1
(43) Pub. Date: Oct. 5, 2023

(54) METHODS AND APPARATUS TO DIRECT TRANSMISSION OF DATA BETWEEN NETWORK-CONNECTED DEVICES

(71) Applicant: Intel Corporation, Santa Clara, CA (US)

(72) Inventors: Rony Ferzli, Chandler, AZ (US); Hassnaa Moustafa, San Jose, CA (US); Rita Hanna Wouhaybi, Portland, OR (US); Francesc Guim Bernat, Barcelona (ES); Rita Chattopadhyay, Chandler, AZ (US)

(21) Appl. No.: 18/328,214

(22) Filed: Jun. 2, 2023

(51) Int. Cl. H04L 41/16; H04L 45/02

(52) U.S. Cl. CPC H04L 41/16; H04L 45/02

(57) ABSTRACT

Systems, apparatus, articles of manufacture, and methods are disclosed that direct transmission of data between network-connected devices including circuitry, instructions, and programmable circuitry to at least one of instantiate or execute the instructions to cause the interface circuitry to identify a neural network (NN) to a first device of a first combination of devices corresponding to a first network topology, cause the first device to process first data with a first portion of the NN, and cause a second device of a second combination of devices to process second data with a second portion of the NN, the second combination of devices corresponding to a second network topology.

### BACKGROUND

In recent years, edge devices in an edge network have shared workloads between other edge devices in the same edge network.

### BRIEF DESCRIPTION OF THE DRAWINGS

FIG. 1 illustrates an overview of an example Edge cloud configuration for Edge computing.

FIG. 2 illustrates example operational layers among endpoints, an Edge cloud, and cloud computing environments.

FIG. 3 illustrates an example approach for networking and services in an Edge computing system.

FIG. 4 is a schematic diagram of an example infrastructure processing unit (IPU).

FIG. 5 illustrates a drawing of an example a cloud computing network, or cloud, in communication with a number of Internet of Things (IoT) devices.

FIG. 6A is a block diagram of an example environment in which example orchestrator node circuitry operates to direct transmission of data between an edge network at a first time.

FIG. 6B is a block diagram of the example environment in which the example orchestrator node circuitry operates to direct transmission of data between the edge network at a second time.

FIG. 7 is a block diagram of an example implementation of the orchestrator node circuitry of FIGS. 6A-6B.

FIG. 8 is an image representation of a neural network inference performed by the example neural network processor circuitry 708 (FIG. 7) of the example one of the compute nodes 604 (FIGS. 6A-6B).

FIG. 9 is a flowchart representative of example machine readable instructions and/or example operations that may be executed, instantiated, and/or performed by example programmable circuitry to implement the orchestrator node circuitry 700 of FIG. 7 to direct transmission of data between network-connected devices.

FIG. 10 is a flowchart representative of example machine readable instructions and/or example operations that may be executed, instantiated, and/or performed by example programmable circuitry to implement the data reduction circuitry 710 of the orchestrator node circuitry 700 of FIG. 7 to determine if the compute node is to use a data reduction function.

FIG. 11 is a flowchart representative of example machine readable instructions and/or example operations that may be executed, instantiated, and/or performed by example programmable circuitry to implement the orchestrator node circuitry 700 of FIG. 7 to determine if the compute node is to transmit data to another compute node.

FIG. 12 is a block diagram of an example processing platform including programmable circuitry structured to execute, instantiate, and/or perform the example machine readable instructions and/or perform the example operations of FIGS. 9, 10, and/or 11 to implement the orchestrator node circuitry 700 of FIG. 7.

FIG. 13 is a block diagram of an example implementation of the programmable circuitry of FIG. 12.

FIG. 14 is a block diagram of another example implementation of the programmable circuitry of FIG. 12.

FIG. 15 is a block diagram of an example software/firmware/instructions distribution platform (e.g., one or more servers) to distribute software, instructions, and/or firmware (e.g., corresponding to the example machine readable instructions of FIGS. 9, 10, and/or 11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In general, machine learning models/architectures that are suitable to use in the example approaches disclosed include deep neural network (DNN), convolutional neural network (CNN), recurrent neural network, random forest classifiers, support vector machines, graph neural network (GNN), feedforwards or any other model. However, other types of machine learning models could additionally or alternatively be used.

In some examples, a neural network (NN) is defined to be a data structure that stores weights. In other examples, the neural network (NN) is defined to be an algorithm or set of instructions. In yet other examples, a neural network is defined to be a data structure that includes one or more algorithms and corresponding weights. Neural networks are data structures that can be stored on structural elements (e.g., memory).

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using the sensor data from the autonomous mobile robots (AMRs). In examples disclosed herein, training is performed until the model is sufficiently trained based on accuracy constraints, latency constraints, and power constraints. In examples disclosed herein, training may be performed locally at the edge device or remotely at a central facility. Training is performed using hyperparameters that control how the learning is performed (e.g., a learning rate, a number of layers to be used in the machine learning model, etc.).

Training is performed using training data. In examples disclosed herein, the training data originates from the streaming data of the autonomous mobile robots (AMRs). In some examples, the training data is pre-processed using, for example, by a first edge device before being sent to a second edge device.

Once training is complete, the model is deployed for use as an executable construct that processes an input and provides an output based on the network of nodes and connections defined in the model. The model is stored at either an orchestrator node or an edge node. The model may then be executed by the edge nodes.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

In some Edge environments and use cases, there is a need for contextually aware applications that meet real-time constraints for availability, responsiveness, and resource constraints on devices. In some examples, manufacturing and warehouse facilities will include multiple different types of autonomous mobile robots (AMRs). There may be any number of AMRs in a warehouse facility performing different tasks that include payload movement, inspection, and package transportation inside the warehouse facility. In some examples, to reduce costs, system designers may use an orchestrator (e.g., Kubernetes®) to stream sensor data from energy-efficient limited-compute-capable AMRs to edge compute nodes with more processing power. The more powerful (e.g., capable) edge compute nodes process the distributed workloads.

Using an orchestrator includes challenges such as the need to use the sensors of the AMRs. In some examples, the sensors are heterogeneous leaf devices (e.g., extension leaves). For example, the edge compute node accesses the camera of the AMR as an extension leaf. Using an extension leaf device may cause delays as the data is captured on the extension leaf device before being processed at a separate device.

Using an orchestrator prioritizes sensor data streams over the network to allow for better quality of service (QoS) based on the operating conditions. For example, other data may be of a relatively higher urgency or importance, but instead the sensor data stream is being sent over the network. Furthermore, relatively large amounts of sensor data are being streamed in some circumstances. For example, a first AMR may include up to four two-mega-pixel (2 MP) cameras that are capturing data at thirty frames per second (30 fps). This same first AMR may include a LiDAR camera which also streams LiDAR data. If there are multiple AMRs, then the data stream grows, which indicates a high network bandwidth on an access point (e.g., a Wi-Fi access point or 5G). In some examples, encoders compress the data stream by a factor (e.g., a factor of ten). In addition, there are latency constraints in applications such as an analytics pipeline and energy constraints in the transmission of the data based on limited compute capabilities on the battery-powered AMR. Further, the orchestrator (both the controller and scheduler) is to determine the use case (e.g., a safety use case, or a critical use case, a non-critical use case) which determines the accuracy SLA. The orchestrator determines the relationships between workloads.

Some techniques (e.g., MPEG-DASH) include compressing the data from the sensors of the AMRs by constantly estimating the bandwidth. These techniques change the resolution and/or frame rate following a predetermined fixed policy. Some techniques include preprocessing the sensor data by using a relatively smaller resolution of sensor data or frame. However, compressing the data or preprocessing the data introduces video artifacts that affect the accuracy of neural network inferencing at the edge compute node that receives the compressed data. In addition, if a neural network is trained with primarily streamed data, then the neural network is only suitable for streams that are compressed at certain bitrates. To accommodate for alternate bitrates requires using a larger neural network model which includes more computation and memory.

Some techniques use a relatively smaller resolution, however using a relatively smaller resolution negatively affects accuracy of detection for an object at a distance. In some examples, typically a window of at least one hundred by one hundred (100×100) pixels is required for detection. Therefore, reducing resolution below two mega-pixels (2 MP) results in misses (e.g., inaccurate results) in ranges between three and ten meters. Some techniques, rather than reduce the resolution, reduce the frame rate. However, reducing the frame rate may result in reduced accuracy and missed action recognition by AMRs which includes safety implications. Finally, some techniques use raw data which places a limit on the number of data streams from the cameras of the AMRs to be transmitted. However, current techniques that use raw data seldom achieve the network bandwidth or service-level-agreement (SLA) requirement(s). The floor plan layout in which the AMRs traverse also influences the network bandwidth and the signal strength. Therefore, compression may be used depending on the floor plan. In some examples, the edge devices are modified to include additional server blades to handle the amount of data streams coming from the multiple AMRs in the edge network. In some examples, there may be a one-to-one relationship between a first AMR and a first edge node, however this one-to-one relationship is neither cost effective nor feasible from a deployment perspective.

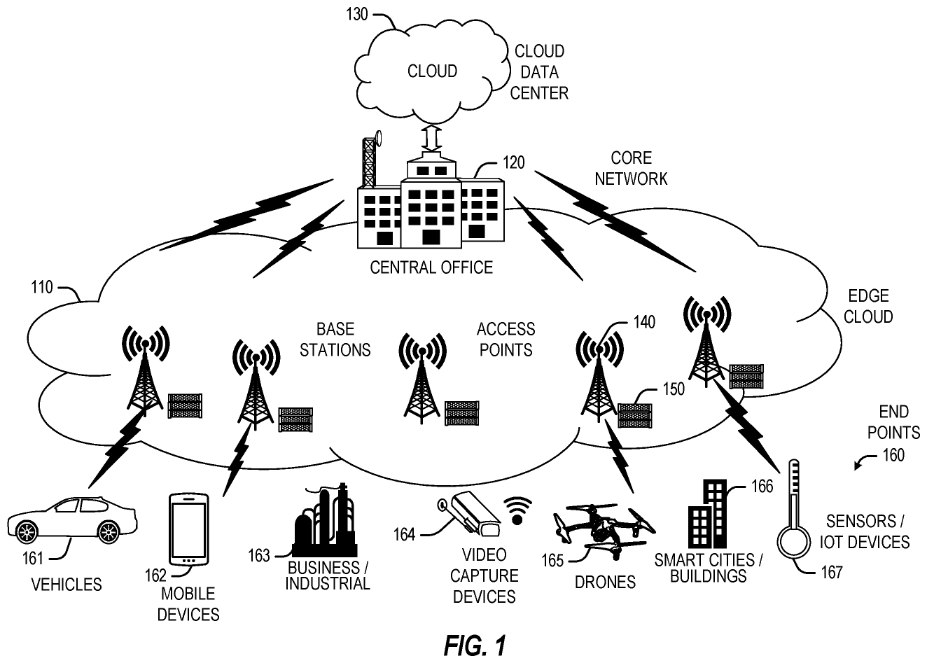

FIG. 1 is a block diagram 100 showing an example overview of a configuration for Edge computing, which includes a layer of processing referred to in many of the following examples as an “Edge cloud”. As shown, the example Edge cloud 110 is co-located at an Edge location, such as an access point or base station 140, a local processing hub 150, or a central office 120, and thus may include multiple entities, devices, and equipment instances. The Edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the Edge cloud 110 are helpful to providing ultra-low latency response times for services and functions used by the endpoint data sources 160 as well as reduce network backhaul traffic from the Edge cloud 110 toward cloud data center 130 thus improving energy consumption and overall network usages among other benefits.

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a computer platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

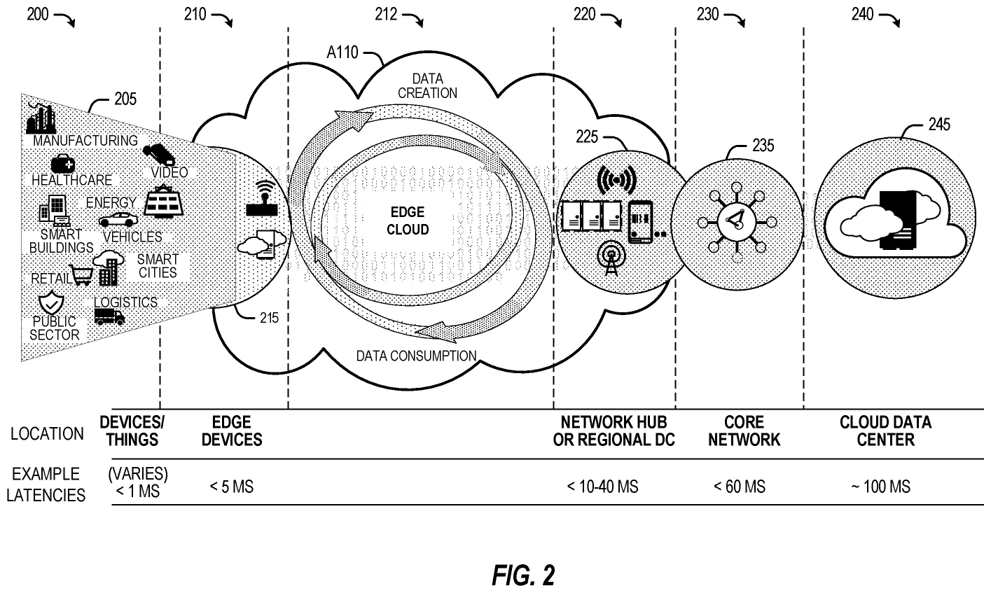

FIG. 2 illustrates example operational layers among endpoints, an Edge cloud, and cloud computing environments. Specifically, FIG. 2 depicts examples of computational use cases 205, utilizing the Edge cloud 110 among multiple illustrative layers of network computing. The layers begin at an endpoint (devices and things) layer 200, which accesses the Edge cloud 110 to conduct data creation, analysis, and data consumption activities. The Edge cloud 110 may span multiple network layers, such as an Edge devices layer 210 having gateways, on-premise servers, or network equipment (nodes 215) located in physically proximate Edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the Edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the Edge devices layer 210, to even between 10 to 40 ms when communicating with nodes at the network access layer 220. Beyond the Edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center 235 or a cloud data center 245, a central office or content data network may be considered as being located within a “near Edge” layer (“near” to the cloud, having high latency values when communicating with the devices and endpoints of the use cases 205), whereas an access point, base station, on-premise server, or network gateway may be considered as located within a “far Edge” layer (“far” from the cloud, having low latency values when communicating with the devices and endpoints of the use cases 205). It will be understood that other categorizations of a particular network layer as constituting a “close”, “local”, “near”, “middle”, or “far” Edge may be based on latency, distance, number of network hops, or other measurable characteristics, as measured from a source in any of the network layers 200-240.

The various use cases 205 may access resources under usage pressure from incoming streams, due to multiple services utilizing the Edge cloud. To achieve results with low latency, the services executed within the Edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, Edge computing within the Edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 110 (network layers 200-240), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 110.

As such, the Edge cloud 110 is formed from network components and functional features operated by and within Edge gateway nodes, Edge aggregation nodes, or other Edge compute nodes among network layers 210-230. The Edge cloud 110 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 110 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

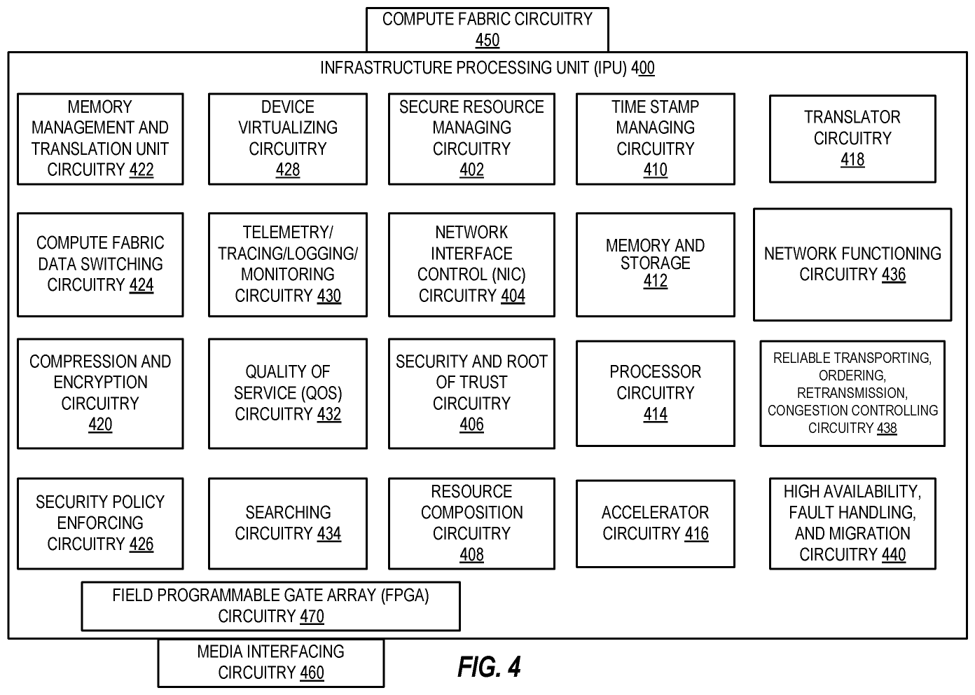

The network components of the Edge cloud 110 may be servers, multi-tenant servers, appliance computing devices, and/or any other type of computing devices. For example, the Edge cloud 110 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIGS. 4, 12, 13 and/or 14. The Edge cloud 110 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

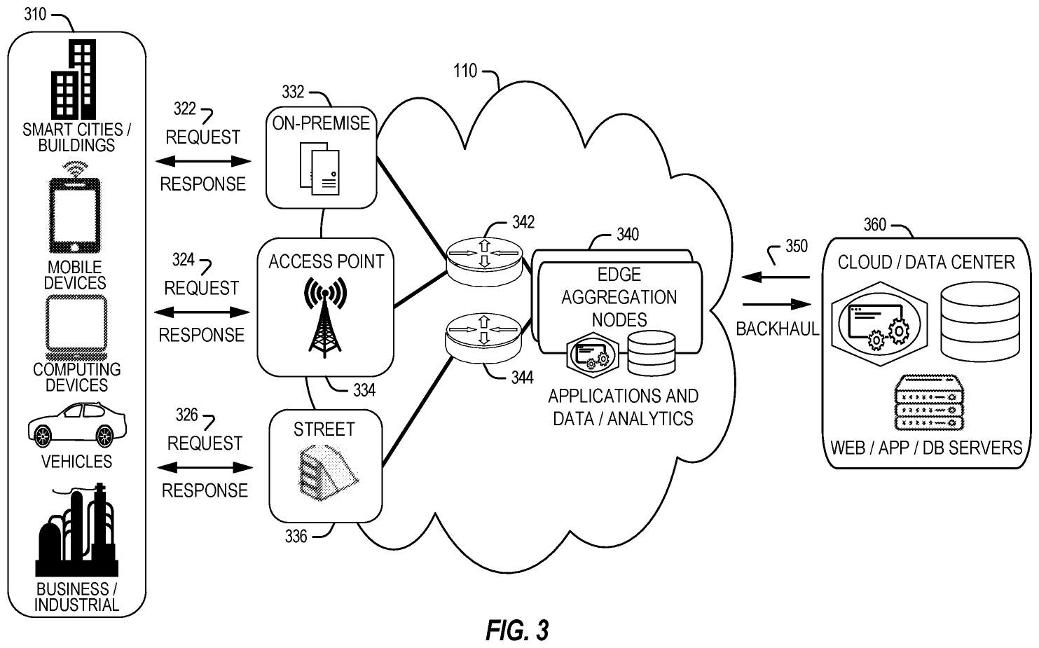

FIG. 3 illustrates an example approach for networking and services in an Edge computing system. In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., a cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the Edge cloud 110 to aggregate traffic and requests. Thus, within the Edge cloud 110, the TSP may deploy various compute and storage resources, such as at Edge aggregation nodes 340, to provide requested content. The Edge aggregation nodes 340 and other systems of the Edge cloud 110 are connected to a cloud or data center 360, which uses a backhaul network 350 to fulfill higher-latency requests from a cloud/data center for websites, applications, database servers, etc. Additional or consolidated instances of the Edge aggregation nodes 340 and the aggregation points 342, 344, including those deployed on a single server framework, may also be present within the Edge cloud 110 or other areas of the TSP infrastructure.

FIG. 4 is a schematic diagram of an example infrastructure processing unit (IPU). Different examples of IPUs disclosed herein enable improved performance, management, security and coordination functions between entities (e.g., cloud service providers), and enable infrastructure offload and/or communications coordination functions. As disclosed in further detail below, IPUs may be integrated with smart NICs and storage or memory (e.g., on a same die, system on chip (SoC), or connected dies) that are located at on-premises systems, base stations, gateways, neighborhood central offices, and so forth. Different examples of one or more IPUs disclosed herein can perform an application including any number of microservices, where each microservice runs in its own process and communicates using protocols (e.g., an HTTP resource API, message service or gRPC). Microservices can be independently deployed using centralized management of these services. A management system may be written in different programming languages and use different data storage technologies.

Furthermore, one or more IPUs can execute platform management, networking stack processing operations, security (crypto) operations, storage software, identity and key management, telemetry, logging, monitoring and service mesh (e.g., control how different microservices communicate with one another). The IPU can access an xPU to offload performance of various tasks. For instance, an IPU exposes XPU, storage, memory, and CPU resources and capabilities as a service that can be accessed by other microservices for function composition. This can improve performance and reduce data movement and latency. An IPU can perform capabilities such as those of a router, load balancer, firewall, TCP/reliable transport, a service mesh (e.g., proxy or API gateway), security, data-transformation, authentication, quality of service (QoS), security, telemetry measurement, event logging, initiating and managing data flows, data placement, or job scheduling of resources on an xPU, storage, memory, or CPU.

In the illustrated example of FIG. 4, the IPU 400 includes or otherwise accesses secure resource managing circuitry 402, network interface controller (NIC) circuitry 404, security and root of trust circuitry 406, resource composition circuitry 408, time stamp managing circuitry 410, memory and storage 412, processing circuitry 414, accelerator circuitry 416, and/or translator circuitry 418. Any number and/or combination of other structure(s) can be used such as but not limited to compression and encryption circuitry 420, memory management and translation unit circuitry 422, compute fabric data switching circuitry 424, security policy enforcing circuitry 426, device virtualizing circuitry 428, telemetry, tracing, logging and monitoring circuitry 430, quality of service circuitry 432, searching circuitry 434, network functioning circuitry (e.g., routing, firewall, load balancing, network address translating (NAT), etc.) 436, reliable transporting, ordering, retransmission, congestion controlling circuitry 438, and high availability, fault handling and migration circuitry 440 shown in FIG. 4. Different examples can use one or more structures (components) of the example IPU 400 together or separately. For example, compression and encryption circuitry 420 can be used as a separate service or chained as part of a data flow with vSwitch and packet encryption.

In some examples, IPU 400 includes a field programmable gate array (FPGA) 470 structured to receive commands from an CPU, XPU, or application via an API and perform commands/tasks on behalf of the CPU, including workload management and offload or accelerator operations. The illustrated example of FIG. 4 may include any number of FPGAs configured and/or otherwise structured to perform any operations of any IPU described herein.

Example compute fabric circuitry 450 provides connectivity to a local host or device (e.g., server or device (e.g., xPU, memory, or storage device)). Connectivity with a local host or device or smartNIC or another IPU is, in some examples, provided using one or more of peripheral component interconnect express (PCIe), ARM AXI, Intel® QuickPath Interconnect (QPI), Intel® Ultra Path Interconnect (UPI), Intel® On-Chip System Fabric (IOSF), Omnipath, Ethernet, Compute Express Link (CXL), HyperTransport, NVLink, Advanced Microcontroller Bus Architecture (AMBA) interconnect, OpenCAPI, Gen-Z, CCIX, Infinity Fabric (IF), and so forth. Different examples of the host connectivity provide symmetric memory and caching to enable equal peering between CPU, XPU, and IPU (e.g., via CXL.cache and CXL.mem).

Example media interfacing circuitry 460 provides connectivity to a remote smartNIC or another IPU or service via a network medium or fabric. This can be provided over any type of network media (e.g., wired or wireless) and using any protocol (e.g., Ethernet, InfiniBand, Fiber channel, ATM, to name a few).

In some examples, instead of the server/CPU being the primary component managing IPU 400, IPU 400 is a root of a system (e.g., rack of servers or data center) and manages compute resources (e.g., CPU, xPU, storage, memory, other IPUs, and so forth) in the IPU 400 and outside of the IPU 400. Different operations of an IPU are described below.

In some examples, the IPU 400 performs orchestration to decide which hardware or software is to execute a workload based on available resources (e.g., services and devices) and considers service level agreements and latencies, to determine whether resources (e.g., CPU, xPU, storage, memory, etc.) are to be allocated from the local host or from a remote host or pooled resource. In examples when the IPU 400 is selected to perform a workload, secure resource managing circuitry 402 offloads work to a CPU, xPU, or other device and the IPU 400 accelerates connectivity of distributed runtimes, reduce latency, CPU and increases reliability.

In some examples, secure resource managing circuitry 402 runs a service mesh to decide what resource is to execute workload, and provide for L7 (application layer) and remote procedure call (RPC) traffic to bypass kernel altogether so that a user space application can communicate directly with the example IPU 400 (e.g., IPU 400 and application can share a memory space). In some examples, a service mesh is a configurable, low-latency infrastructure layer designed to handle communication among application microservices using application programming interfaces (APIs) (e.g., over remote procedure calls (RPCs)). The example service mesh provides fast, reliable, and secure communication among containerized or virtualized application infrastructure services. The service mesh can provide critical capabilities including, but not limited to service discovery, load balancing, encryption, observability, traceability, authentication and authorization, and support for the circuit breaker pattern.

In some examples, infrastructure services include a composite node created by an IPU at or after a workload from an application is received. In some cases, the composite node includes access to hardware devices, software using APIs, RPCs, gRPCs, or communications protocols with instructions such as, but not limited, to iSCSI, NVMe-oF, or CXL.

In some cases, the example IPU 400 dynamically selects itself to run a given workload (e.g., microservice) within a composable infrastructure including an IPU, xPU, CPU, storage, memory, and other devices in a node.

In some examples, communications transit through media interfacing circuitry 460 of the example IPU 400 through a NIC/smartNIC (for cross node communications) or loopback back to a local service on the same host. Communications through the example media interfacing circuitry 460 of the example IPU 400 to another IPU can then use shared memory support transport between xPUs switched through the local IPUs. Use of IPU-to-IPU communication can reduce latency and jitter through ingress scheduling of messages and work processing based on service level objective (SLO).

For example, for a request to a database application that requires a response, the example IPU 400 prioritizes its processing to minimize the stalling of the requesting application. In some examples, the IPU 400 schedules the prioritized message request issuing the event to execute a SQL query database and the example IPU constructs microservices that issue SQL queries and the queries are sent to the appropriate devices or services.

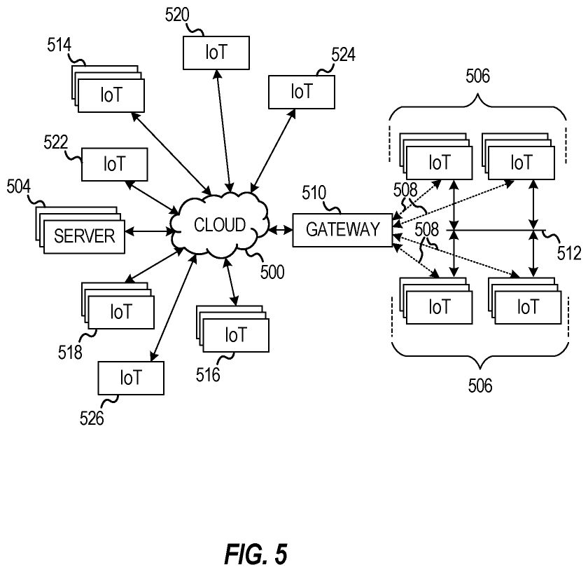

FIG. 5 illustrates a drawing of a cloud computing network, or cloud 500, in communication with a number of Internet of Things (IoT) devices. The cloud 500 may represent the Internet, or may be a local area network (LAN), or a wide area network (WAN), such as a proprietary network for a company. The IoT devices may include any number of different types of devices, grouped in various combinations. For example, a traffic control group 506 may include IoT devices along streets in a city. These IoT devices may include stoplights, traffic flow monitors, cameras, weather sensors, and the like. The traffic control group 506, or other subgroups, may be in communication with the cloud 500 through wired or wireless links 508, such as LPWA links, and the like. Further, a wired or wireless sub-network 512 may allow the IoT devices to communicate with each other, such as through a local area network, a wireless local area network, and the like. The IoT devices may use another device, such as a gateway 510 to communicate with remote locations such as the cloud 500; the IoT devices may also use one or more servers 504 to facilitate communication with the cloud 500 or with the gateway 510. For example, the one or more servers 504 may operate as an intermediate network node to support a local Edge cloud or fog implementation among a local area network. Further, the gateway 510 that is depicted may operate in a cloud-to-gateway-to-many Edge devices configuration, such as with the various IoT devices node 514, 520, 524 being constrained or dynamic to an assignment and use of resources in the cloud 500.

Other example groups of IoT devices may include remote weather stations 514, local information terminals 516, alarm systems 518, automated teller machines 520, alarm panels 522, or moving vehicles, such as emergency vehicles 524 or other vehicles 526, among many others. Each of these IoT devices may be in communication with other IoT devices, with servers 504, with another IoT fog device or system, or a combination therein. The groups of IoT devices may be deployed in various residential, commercial, and industrial settings (including in both private or public environments).

As may be seen from FIG. 5, a large number of IoT devices may be communicating through the cloud 500. This may allow different IoT devices to request or provide information to other devices autonomously. For example, a group of IoT devices (e.g., the traffic control group 506) may request a current weather forecast from a group of remote weather stations 514, which may provide the forecast without human intervention. Further, an emergency vehicle 524 may be alerted by an automated teller machine 520 that a burglary is in progress. As the emergency vehicle 524 proceeds towards the automated teller machine 520, it may access the traffic control group 506 to request clearance to the location, for example, by lights turning red to block cross traffic at an intersection in sufficient time for the emergency vehicle 524 to have unimpeded access to the intersection.

Clusters of IoT devices, such as the remote weather stations 514 or the traffic control group 506, may be equipped to communicate with other IoT devices as well as with the cloud 500. This may allow the IoT devices to form an ad-hoc network between the devices, allowing them to function as a single device, which may be termed a fog device or system.

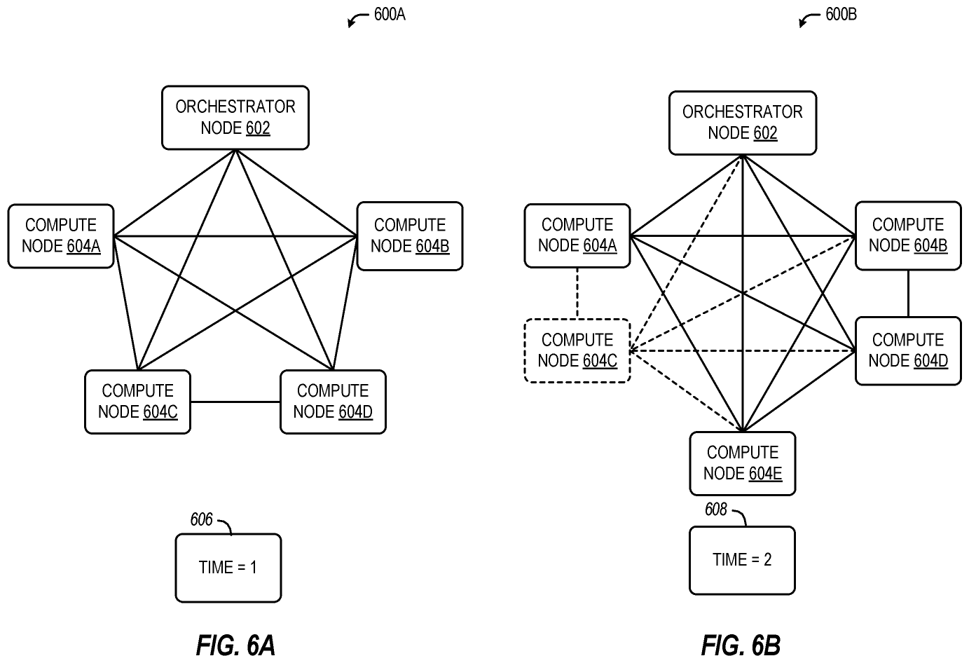

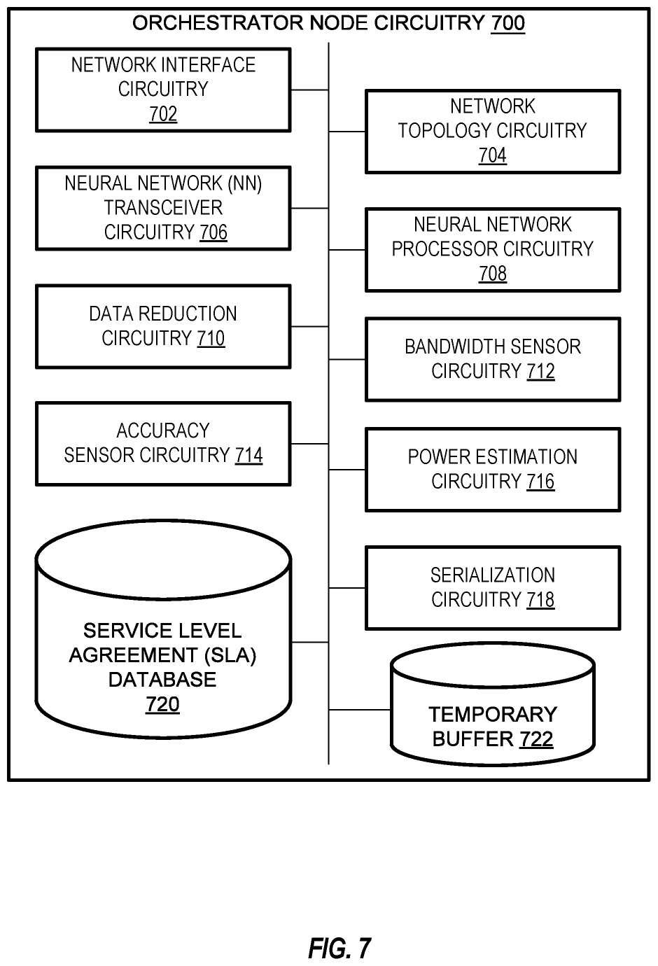

FIG. 6A is a block diagram of an example edge network 600A in which example orchestrator node circuitry 700 (see FIG. 7 and discussed further below) operates to direct transmission of data between the edge network 600A at a first time 606. In some examples, the orchestrator node circuitry 700 (FIG. 7) is executed from an example orchestrator node 602. In other examples, an example first compute node 604A may execute the orchestrator node circuitry 700 (FIG. 7). In some examples, the orchestrator node circuitry 700 (FIG. 7) is executed on autonomous mobile robots and/or the AMRs may include the orchestrator node circuitry 700. The example compute nodes 604 (e.g., the first compute node 604A, the second compute node 604B, etc.) include neural network processor circuitry 708 (FIG. 7) to execute workloads and perform neural network inference. In some examples, the compute nodes 604 may be edge-connected devices, autonomous mobile robots (AMRs), edge nodes, distributed edge devices etc. The example compute nodes 604 may each have a different memory, a different processing capability, a different battery level, and a different latency from the other example compute nodes 604.

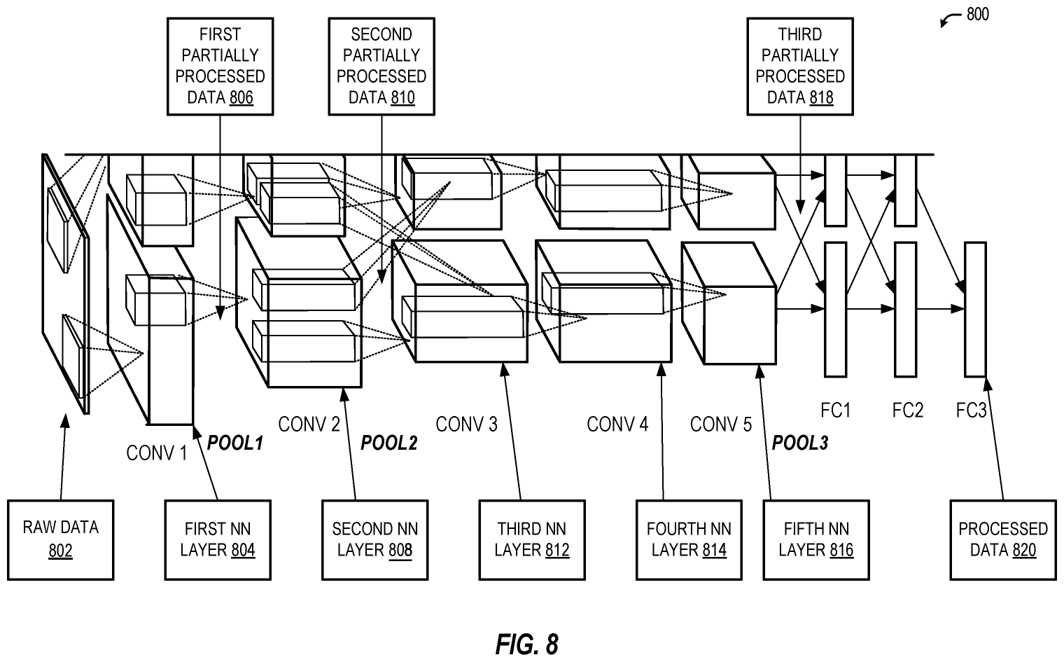

As used herein, an edge network has a network topology. The network topology shows the connections (e.g., particular connection relationships) between the compute nodes 604 and the orchestrator node 602 in the edge network 600A. For example, the network topology has a unique number of compute nodes 604. The network topology illustrates how the compute nodes 604 are connected to the other compute nodes 604. The combination of compute nodes 604 correspond to a first network topology with certain capabilities (e.g., compute capabilities). At an example first time 606, the network topology includes one example orchestrator node 602, and four example compute nodes 604 (e.g., the example first compute node 604A, the example second compute node 604B, the example third example compute node 604C, and the example fourth compute node 604D). At the example first time 606, the example first compute node 604A may receive input data (e.g., sensor data, radar, lidar, audio etc.) from an autonomous mobile device (not shown) or another compute node (e.g., the fourth compute node 604D). The example first compute node 604A begins neural network processing (e.g., neural network inference) on the input data to generate an intermediate output. The example first compute node 604A may begin processing the input data with an example first neural network. As described in connection with FIG. 8, the example first neural network includes multiple layers.

The network topology is dynamic (e.g., changing with respect to time) and open (e.g., the availability of compute nodes fluctuates as compute nodes enter and exit the edge network). At an example second time 608, the orchestrator node 602 probes, examines and/or otherwise analyzes the network topology of the edge network 600A. In response to the probe, the example orchestrator node 602 has determined that the network topology has changed to correspond to an example edge network 600B (e.g., a second edge network). The network topology, at the second time 608, includes one example orchestrator node 602 and five example compute nodes 604. For example, the network topology at the second time 608 has certain compute capabilities that are different from certain compute capabilities of the first network topology.

FIG. 6B is a block diagram of the example environment in which the example orchestrator node circuitry operates to direct transmission of data between the edge network at a second time. In the illustrated example of FIG. 6B, the third compute node 604C is now unavailable for processing, as illustrated by the dashed border, resulting in a total of four example compute nodes 604 available for processing. In some examples, the third compute node 604C may be unavailable for processing due to malfunction. Alternatively, the example third compute node 604C may be using a majority of compute power on other workloads and has no more capacity for new workloads at the second time 608.

In the example of FIG. 6B, an example fifth compute node 604E is available for processing. For example, the fifth compute node 604E may have recently finished processing some workloads and now has an availability (e.g., ability, capacity, etc.) to process additional workloads. In other examples, the fifth compute node 604E may have moved into a location (e.g., proximity to the edge network 600B) that allows for transfers of the workloads with a response time that satisfies a target service level agreement.

In response to the dynamic network topology, the example orchestrator node 602 may determine, based on a service level agreement (SLA), to transfer the intermediate output (e.g., partially processed input data, intermediate results from the first layers of the neural network) to the example second compute node 604B. In some examples, the intermediate output is the output from the example first compute node 604A which processed some, but not all of the input data. In some examples, the orchestrator node 602 transmits an identifier corresponding to the neural network layer of the neural network that was scheduled to be used by the first compute node 604A before the orchestrator node 602 transferred the intermediate output. By transferring the neural network layer identifier, the second compute node 604B is able to continue neural network processing and inference on the intermediate output. In some examples, the orchestrator node 602 causes the first compute node 604A to reduce the intermediate output with a data reduction function based on the service level agreement before the intermediate output is transferred to the second compute node 604B.

The example orchestrator node 602 is to direct the transmission of the data as the edge network 600A dynamically changes into the edge network 600B. In some examples, the orchestrator node 602 optimizes processing of sensor data at the compute nodes 604 based on use case requirements, available bandwidth settings, and recognized critical scenarios. For example, the first compute node 604A may, as a result of neural network inference, determine (e.g., recognize) that the sensor data being transmitted corresponds to a critical scenario (e.g., accident, emergency, etc.). In response, the orchestrator node 602 transfers and/or otherwise causes the transfer of the workload of the sensor data to an example second compute node 604B to complete processing, if the second compute node 604B is able to process the sensor data faster or more accurately than the example first compute node 604A.

In some examples, the orchestrator node 602 directs transmission and/or otherwise causes transmission of the data by causing (e.g., instructing) the first compute node 604A to reduce the data being transmitted with a reduction function (e.g., utility function, transformation function) before encoding (e.g., serializing) the data for transmission. For example, the orchestrator node 602 determines that the quality profile used by a video encoder instantiated by example serialization circuitry 718 (FIG. 7) for a camera stream is based on telemetry for bandwidth estimation and resource availability on the edge compute node 604A.

In some examples, the orchestrator node 602 directs transmission of the data by causing (e.g., instructing) the second compute node 604B to decode the encoded (e.g., serialized) data before continuing neural network inference or further reducing the now decoded data. For example, the second compute node 604B includes the neural network model (e.g., DNN model) and the weights used in the neural network model. The second compute node 604B receives an instruction from the orchestrator node 602. The example orchestrator node 602 sends a lookup table for different compression ratios. The different compression ratios correspond to the different neural networks that were deployed to perform the neural network inference.

In some examples, the orchestrator node 602 accesses a service level agreement (SLA) database 720 (FIG. 7). The SLA database 720 (FIG. 7) includes configuration profiles for the serialization circuitry 718 (FIG. 7) (e.g., transmitter, receiver). The configuration profiles may be selected to permit particular requirements for latency performance, battery power performance, accuracy performance, and/or speed performance metrics.

In some examples, the orchestrator node 602 provides a feedback loop from the second compute node 604B (e.g., the receiver) to the first compute node 604A (e.g., the transmitter). The feedback loop allows the orchestrator node 602 to adjust the deployed workloads and profiles. For example, the orchestrator node 602 causes the first compute node 604A to use a reduction function (e.g., utility function), the reduction function employed and/or otherwise applied in real time (e.g., on the fly) between the first compute node 604A and the second compute node 604B.

The example orchestrator node 602 allows services (e.g., edge nodes, edge network services) to subscribe to one or more data size reduction function(s) that can be used at the source (e.g., transmitter) to modify the data being streamed to that service based on the amount of available bandwidth on the network and the service level objectives that correspond to the service. For example, the orchestrator node 602, for a safety use case, may instruct the first compute node 604A to use a data size reduction function that reduces the resolution of a video stream from 1080 pixels to 720 pixels. The example orchestrator node 602 sets the parameters of the data size reduction function to be dynamically set based on the service level agreements (SLAs). For example, the orchestrator node 602 determines a first use case results in best accuracy at 1080 pixel resolution, good accuracy at 720 pixel resolution, and acceptable accuracy at 540 pixel resolution. The example orchestrator node 602 determines that 1080 pixel resolution corresponds to ninety percent accuracy, the 720 pixel resolution corresponds to seventy percent accuracy, and the 540 pixel resolution corresponds to sixty percent accuracy. The example orchestrator node 602 determines, based on the pixel resolution and the accuracy percentage for the first use case, that five percent of the total operation time, the pixel resolution which results in approximately seventy percent accuracy may be utilized, and that two percent of the total operation time, the pixel resolution which results in approximately sixty percent accuracy may be utilized.

In some examples, the example orchestrator node 602 is to determine the CPU architecture features, that are battery-power aware, of the compute nodes 604 (e.g., edge devices) to match workloads with environment constraints (e.g., network bandwidth) and SLA requirements (e.g., latency, accuracy required at different distances, and recognized critical scenarios).

In some examples, the example orchestrator node circuitry 700 (FIG. 7) is executed on the example first compute node 604A. In such examples, the compute nodes 604 are peer devices that may transfer and process data and execute one or more portions of a neural network. For example, the first compute node 604A may process first data with a first portion of a neural network to generate second data. The first compute node 604A may transmit the second data and a second portion of the neural network to a first peer device (e.g., the second compute node 604B) in response to determining that the combination of peer devices changed from a first combination of peer devices to a second combination of peer devices. The example first compute node 604A causes the second compute node 604B (e.g., the first peer device) to process the second data with the second portion of the neural network.

In such examples where the orchestrator node circuitry 700 (FIG. 7) is executed on the first compute node 604A, the first compute node 604A may execute a data reduction function on the first data to generate reduced data. In some examples, the first compute node 604A transmits the reduced data to the second compute node 604B (e.g., the first peer device). In some examples, the first compute node 604A processes the first data with a first portion of the neural network before executing the data reduction function on the first data. In such examples, after both neural network processing and data reduction occurs, the reduced data is transmitted to the second compute node 604B.

In such examples where the orchestrator node circuitry 700 (FIG. 7) is executed on the first compute node 604A, the first compute node 604A determines a first (service level agreement) SLA that corresponds to the first combination of peer-devices (e.g., at first time 606) and second SLA that corresponds to the second combination of peer devices (e.g., at a second time 608). In such examples, the second SLA is different than the first SLA. The example first compute node 604A may determine a number of neural network layers that remain to process the second data, and determine a first processing time that relates to locally processing the second data on the first compute node 604A with the number of neural network layers that remain. The example first compute node 604A compares a second processing time that corresponds to transferring the second data to the first peer device (e.g., the second compute node 604B) with the first processing time that corresponds to locally processing the second data with the number of neural network layers that remain.

FIG. 7 is a block diagram of an example implementation of the orchestrator node circuitry 700 of FIGS. 6A-6B. The example orchestrator node circuitry 700 is executed in the orchestrator nodes 602 or the compute nodes 604 of FIGS. 6A-6B to control and direct transmission (e.g., wireless) of data in the edge network 600. The orchestrator node circuitry 700 of FIG. 7 may be instantiated (e.g., creating an instance of, bring into being for any length of time, materialize, implement, etc.) by programmable circuitry such as a Central Processor Unit (CPU) executing first instructions. Additionally or alternatively, the orchestrator node circuitry of FIGS. 6A-6B may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

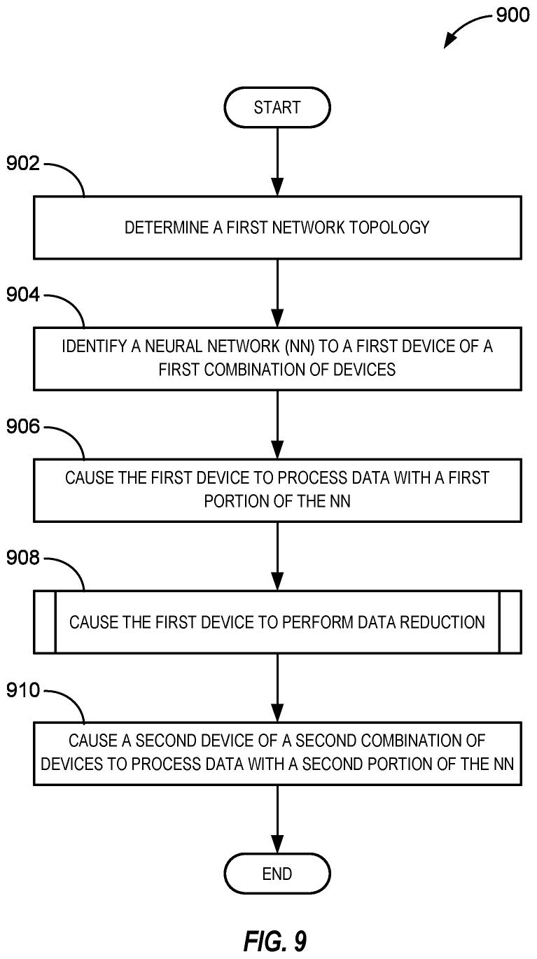

The orchestrator node circuitry 700 includes example network interface circuitry 702, example network topology circuitry 704, example neural network transceiver circuitry 706, example neural network processor circuitry 708, example data reduction circuitry 710, example bandwidth sensor circuitry 712, example accuracy sensor circuitry 714, example power estimation circuitry 716, example serialization circuitry 718, an example service level agreement database 720, and an example temporary buffer 722. In some examples, the orchestrator node circuitry 700 is instantiated by programmable circuitry executing orchestrator node instructions and/or configured to perform operations such as those represented by the flowchart(s) of FIGS. 9-11. In the example of FIG. 7, the orchestrator node circuitry 700 is executed on the first compute node 604A. However, in other examples, the orchestrator node 602 executes the orchestrator node circuitry 700.

The network interface circuitry 702 of the example orchestrator node circuitry 700 is to connect the orchestrator node 602 (FIGS. 6A-6B) to one or more portions of the edge network 600 (FIGS. 6A-6B) that includes a combination of the compute nodes 604 (FIGS. 6A-6B). In some examples, the compute nodes 604 (FIGS. 6A-6B) are a plurality of network-connected devices (e.g., wired, wireless or combinations thereof). The example network interface circuitry 702 is to transmit the status of the availability and compute ability of the first compute node 604A (FIGS. 6A-6B) to the other compute nodes 604 (FIGS. 6A-6B) of the edge network 600 (FIGS. 6A-6B). The example network interface circuitry 702 is to transmit the service-level agreement (SLA) requirement which may include a latency requirement, an accuracy requirement, a power requirement, and a speed requirement. In some examples, the network interface circuitry 702 is to include the functionality of at least one of the example network topology circuitry 704, the example neural network transceiver circuitry 706, or the example serialization circuitry 718. In some examples, the network interface circuitry 702 is instantiated by programmable circuitry executing network interface instructions and/or configured to perform operations such as those represented by the flowchart(s) of FIGS. 9-11.

The network topology circuitry 704 of the example orchestrator node circuitry 700 is to determine the network topology of the edge network 600 (FIGS. 6A-6B) (e.g., in response to a probe, a trigger and/or a request to determine a current topology etc.). For example, the network topology circuitry 704 may determine an availability status by probing the other compute nodes 604 (FIGS. 6A-6B).

The network topology of the edge network 600 (FIGS. 6A-6B) is dynamic and therefore changes over time with new availabilities of compute nodes 604 having corresponding new or alternate processing capabilities. In some examples, the network topology circuitry 704 may determine that the example third compute node 604C (FIGS. 6A-6B) is no longer available for data processing. In other examples, the network topology circuitry 704 may determine that an example fifth compute node 604E (FIG. 6B) that was previously not a part of the network topology of the edge network 600A (FIG. 6A) is now available for data processing at a second time 608 (FIG. 6B). In yet other examples, the network topology circuitry 704 may determine that a third compute node 604C (FIGS. 6A-6B) that had a compute processing availability at a first time, now has more compute processing availability at a second time. The example third compute node 604C (FIGS. 6A-6B) may have more compute processing availability due to the third compute node 604C (FIGS. 6A-6B) finishing a first workload. In some examples, the network topology circuitry 704 is instantiated by programmable circuitry executing network topology instructions and/or configured to perform operations such as those represented by the flowchart(s) of FIGS. 9-11.

The neural network (NN) transceiver circuitry 706 of the example orchestrator node circuitry 700 is to transmit and/or receive layers of a neural network to other compute nodes 604 (FIGS. 6A-6B) of the edge network 600 (FIGS. 6A-6B). In some examples, the neural network transceiver circuitry 706 is to send a portion of the neural network (e.g., a first layer of the neural network, all layers after the fifth layer of the neural network). The example neural network transceiver circuitry 706 is to access an example temporary buffer 722 to retrieve the intermediate results (e.g., partially processed input data). In some examples, the neural network transceiver circuitry 706 is to retrieve an identification key (e.g., identifier) that corresponds to the neural network layer that was previously used by one of the other compute nodes 604 (FIGS. 6A-6B). In such examples, the identification key may also correspond to the specific neural network that includes the neural network layers (e.g., a first neural network layer was the exact neural network that was most recently used on the example first compute node 604A (FIGS. 6A-6B). In some examples, the neural network transceiver circuitry 706 is instantiated by programmable circuitry executing neural network transceiver instructions and/or configured to perform operations such as those represented by the flowchart(s) of FIGS. 9-11. As used herein, the ordering of the nodes is for identification and illustration.

The neural network (NN) processor circuitry 708 is to perform neural network inference. In some examples, the neural network processor circuitry 708 performs inference on data received by at least one of the compute nodes 604 (FIG. 6) (e.g., a first network-connected device, an autonomous mobile robot) or the orchestrator node 602 (FIG. 6). In some examples, the neural network processor circuitry 708 is instantiated by programmable circuitry executing neural network (NN) processing instructions and/or configured to perform operations such as those represented by the flowchart(s) of FIGS. 9-11.

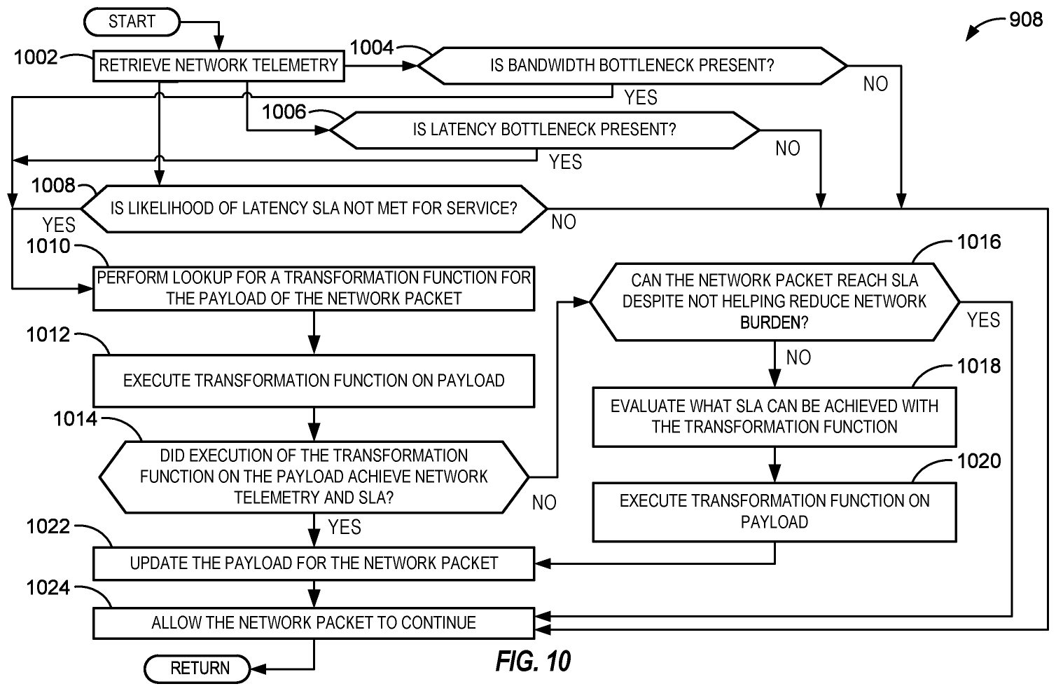

The example data reduction circuitry 710 is to reduce one or more characteristics (e.g., data size, data resolution, etc.) of the data before the data is transferred (e.g., transmitted, sent, etc.) to the second compute node 604B (FIGS. 6A-6B) from the first compute node 604A (FIGS. 6A-6B). In some examples, the data reduction circuitry 710 is to reduce intermediate results (e.g., partially processed data) before the intermediate results are transferred (e.g., transmitted, sent, etc.). The example data reduction circuitry 710 is to reduce the data in accordance with the instructions 908 of FIG. 10 described in further detail below. The example data reduction circuitry 710 is to retrieve the service level agreement (SLA) (e.g., parameters of the SLA) from the example service level agreement (SLA) database 720. The example SLA includes any number and/or type of parameters, such as, at least one of an accuracy requirement, a power requirement, or a latency requirement.

For example, the data reduction circuitry 710 is to reduce the data based on satisfying the accuracy requirement from the SLA. In some examples, the more that data is reduced (e.g., image size is reduced from 16-bits to 4-bits), the larger the chance for an inaccurate neural network inference output. As the data is reduced, there are less visual artifacts used in the neural network inference which increases the probability of an inaccurate measurement. The data reduction circuitry 710 uses the SLA that corresponds to the accuracy requirement. For example, the neural network processor circuitry 708 performs neural network inference on a 16-bit image and typically generates outputs that are accurate ninety percent of the time. If the accuracy requirement is for outputs that are accurate for only eighty percent of the time, then the data reduction circuitry 710 may reduce the number of bits in the 16-bit image to 8 bits. However, if the accuracy drops to below eighty percent, then the data reduction circuitry 710 will not reduce the number of bits in the 16-bit image. In some examples, the orchestrator node 602 or the first compute node 604A use the example accuracy sensor circuitry 714 to determine the accuracy that the node is able to generate with the neural network processor circuitry 708.

Similarly, the data reduction circuitry 710 may access a latency requirement (e.g., the amount of time between sending a request for neural network inference and receiving an output) to determine the factor that the data reduction circuitry 710 is going to reduce the data. As the data is reduced (e.g., a reduction in bandwidth), the data typically is able to be sent relatively faster over the network and downloaded relatively faster onto the second compute node 604B (FIGS. 6A-6B). The example orchestrator node 602 or the first compute node 604A is to use the bandwidth sensor circuitry 712 to determine an availability for the particular node to perform neural network inference once a request for neural network inference is received from another one of the compute nodes 604. For example, the second compute node 604B may currently be performing neural network inference on intermediate data and expect to complete the neural network inference in a first time (e.g., two seconds). After the second compute node 604B completes the neural network inference, the second compute node 604B is now available to start performing neural network inference on other intermediate data. In response to the completion of the first neural network inference, the example bandwidth sensor circuitry 712 is to indicate to the network interface circuitry 702 or the network topology circuitry 704 that the second compute node 604B is available for processing data. The example network interface circuitry 702 or the network topology circuitry 704 is to indicate to the orchestrator node 602 or the other compute nodes 604 of the edge network 600 that the current compute node of the compute nodes 604 has bandwidth to perform neural network inference.

For example, if a first compute node 604A has a latency requirement (e.g., response requirement) of a first time (e.g., five seconds), but the estimation of time for the first compute node 604A to complete the neural network inference is a second time (e.g., ten seconds) where the second time is longer than the first time (e.g., five seconds), then the example first compute node 604A will use the data reduction circuitry 710 and the network topology circuitry 704 to determine if there is a second compute node 604B that is able to perform the neural network inference in a third time (e.g., three seconds) that is shorter than the first time (e.g., five seconds). The data reduction circuitry 710 may reduce the data so that the second compute node 604B is able to perform the neural network inference in a fourth time (e.g., two seconds) that is shorter than the first time (e.g., five seconds), which accounts for time utilized in network transmission both to the second compute node 604B and from the second compute node 604B. Therefore, with an example one second of transmission time to the second compute node, neural network inference on the data-reduced data which is scheduled to take two seconds, and one second of transmission time back to the first compute node, the first compute node has achieved the latency requirement of five seconds, as set forth in the SLA database 720.

Similarly, the data reduction circuitry 710 may access a power requirement (e.g., the amount of battery power used in either performing neural network inference and/or transmitting the request for another node to perform neural network inference) to determine the factor that the data reduction circuitry 710 is going to reduce the data. The example power estimation circuitry 716 is to determine (e.g., estimate) the battery power utilized in performing the neural network inference. In some examples, transmitting less data requires less power than transmitting more data. In some examples, the data reduction circuitry 710 is instantiated by programmable circuitry executing data reduction instructions and/or configured to perform operations such as those represented by the flowchart(s) of FIGS. 9-11.

The example bandwidth sensor circuitry 712 is to determine (e.g., estimate) the availability of the first compute node 604A to perform neural network inference for other compute nodes 604 of the edge network 600. In some examples, the bandwidth (e.g., availability estimate, latency estimate) is used by the data reduction circuitry 710 to determine a factor to reduce the data before transmission to a second compute node 604B. In some examples, the bandwidth sensor circuitry 712 is instantiated by programmable circuitry executing bandwidth sensor instructions and/or configured to perform operations such as those represented by the flowchart(s) of FIGS. 9-11.

The example accuracy sensor circuitry 714 is to determine (e.g., estimate) the accuracy achieved in performing the neural network inference. In some examples, the accuracy estimate is used by the data reduction circuitry 710 to determine a factor to reduce the data before transmission to a second compute node 604B. In some examples, the accuracy sensor circuitry 714 is instantiated by programmable circuitry executing accuracy sensor instructions and/or configured to perform operations such as those represented by the flowchart(s) of FIGS. 9-11.

The example power estimation circuitry 716 is to determine (e.g., estimate) the battery power utilized in performing the neural network inference. In some examples, the power estimate is used by the data reduction circuitry 710 to determine a factor to reduce the data before transmission to a second compute node 604B. In some examples, the power estimation circuitry 716 is instantiated by programmable circuitry executing power estimation instructions and/or configured to perform operations such as those represented by the flowchart(s) of FIGS. 9-11.

The example serialization circuitry 718 is to serialize and deserialize the data that is sent to the other compute nodes 604. In some examples, the example serialization circuitry 718 is to serialize (e.g., encode) the intermediate data that has been processed through at least one layer of the neural network by the neural network processor circuitry 708. In some examples, at the second compute node 604B which receives the request for neural network inference, uses the serialization circuitry 718 to de-serialize (e.g., decode) the intermediate data. In some examples, the serialization circuitry 718 is instantiated by programmable circuitry executing serialization instructions and/or configured to perform operations such as those represented by the flowchart(s) of FIGS. 9-11.

The example service level agreement (SLA) database 720 includes different service level agreements. For example, the service level agreement may include a latency requirement, a power requirement, or an accuracy requirement. The network topology circuitry 704 probes the edge network 600 after the completion of ones of the layers of the neural network to determine if other compute nodes 604 in the edge network 600 are available for processing, which allows the first compute node 604A to meet the requirements set forth in the service level agreement. In some examples, the service level agreement (SLA) database 720 is any type of mass storage device.

The example temporary buffer 722 is to store the intermediate results. For example, after the data is processed through a first layer of the neural network, the neural network processor circuitry may, in response to an instruction, collect (e.g., compact) the outputs generated by one or more neurons of the neural network layer and store the collected outputs in the example temporary buffer 722. The example network interface circuitry 702 is to transmit the compacted outputs that are stored in the temporary buffer 722 to the second compute node 604B which is to begin neural network inference on the second layer, the second layer which is the subsequent layer from the first layer. In some examples, the temporary buffer 722 is any type of mass storage device or memory device.

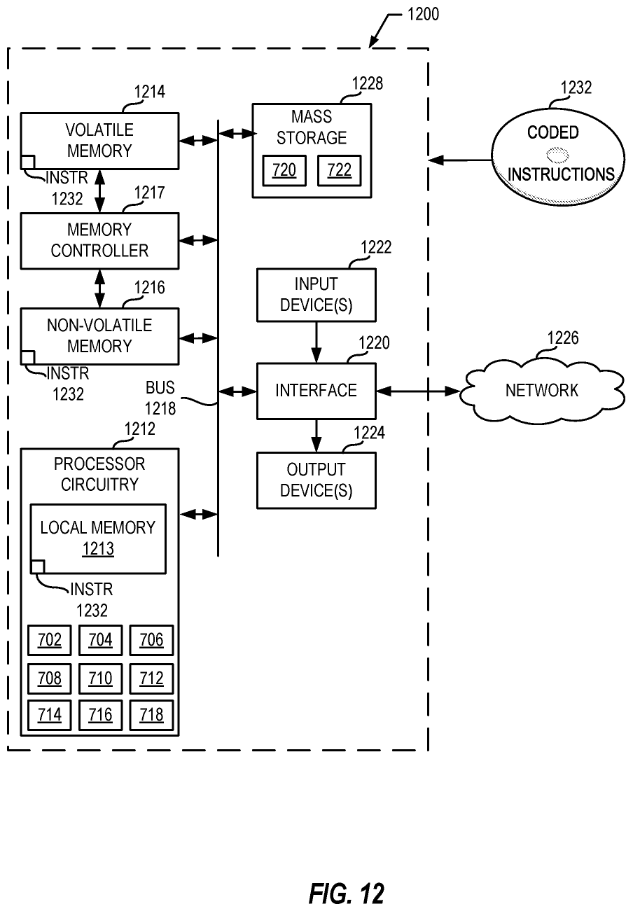

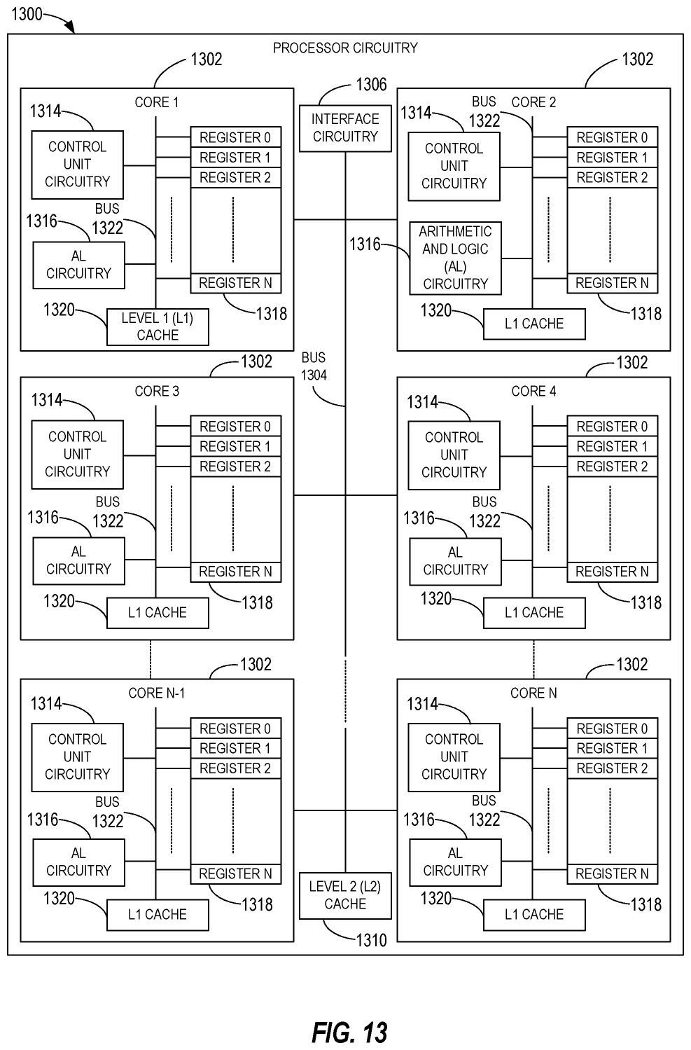

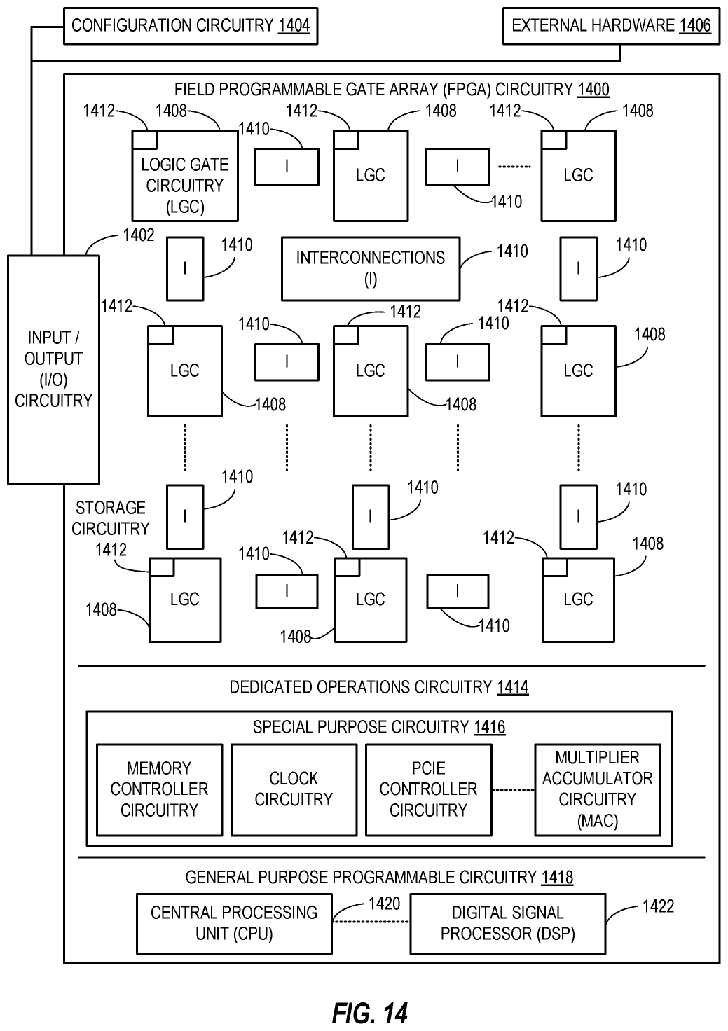

In some examples, the orchestrator node circuitry 700 includes means for causing a device to process data with a portion neural network. For example, the means for causing a device to process data with a portion of neural network be implemented by network interface circuitry 702. In some examples, the network interface circuitry 702 may be instantiated by programmable circuitry such as the example programmable circuitry 1212 of FIG. 12. For instance, the network interface circuitry 702 may be instantiated by the example microprocessor 1300 of FIG. 13 executing machine executable instructions such as those implemented by at least blocks 906 and 910 of FIG. 9 and blocks 1022, 1024 of FIG. 10. In some examples, the network interface circuitry 702 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the network interface circuitry 702 may be instantiated by any other combination of hardware, software, and/or firmware. For example, the network interface circuitry 702 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the orchestrator node circuitry 700 includes means determining a first network topology. For example, the means for determining a first network topology may be implemented by network topology circuitry 704. In some examples, the network topology circuitry 704 may be instantiated by programmable circuitry such as the example programmable circuitry 1212 of FIG. 12. For instance, the network topology circuitry 704 may be instantiated by the example microprocessor 1300 of FIG. 13 executing machine executable instructions such as those implemented by at least blocks 902 of FIG. 9 and 1002, 1006, 1008 of FIG. 10. In some examples, the network topology circuitry 704 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the network interface circuitry 702 and/or the network topology circuitry 704 may be instantiated by any other combination of hardware, software, and/or firmware. For example, the network topology circuitry 704 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

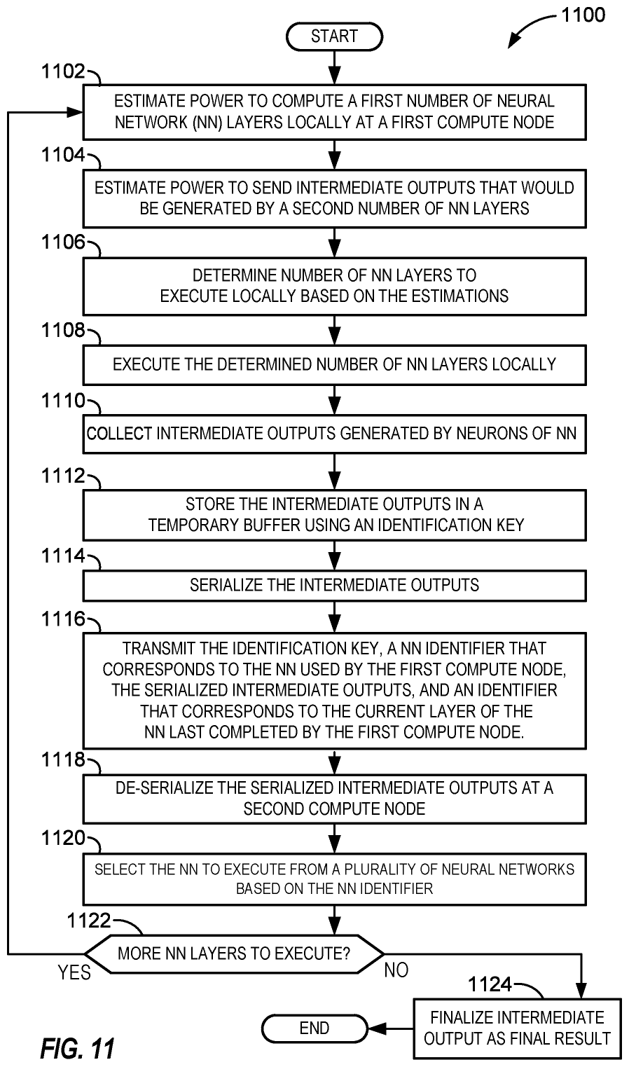

In some examples, the orchestrator node circuitry 700 includes means for identifying a neural network to a first device of a first combination of devices. For example, the means for identifying may be implemented by the network interface circuitry 702. In some examples, the means for identifying may be implemented by the neural network transceiver circuitry 706. In some examples, the network interface circuitry 702 may be instantiated by programmable circuitry such as the example programmable circuitry 1212 of FIG. 12. For instance, the network interface circuitry 702 may be instantiated by the example microprocessor 1300 of FIG. 13 executing machine executable instructions such as those implemented by at least blocks 904 of FIG. 9 and 1116 of FIG. 11. In some examples, network interface circuitry 702 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the network interface circuitry 702 may be instantiated by any other combination of hardware, software, and/or firmware. For example, the network interface circuitry 702 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the orchestrator node circuitry 700 includes means for transmitting a neural network to a first device of a first combination of devices. For example, the means for transmitting may be implemented by neural network transceiver circuitry 706. In some examples, the neural network transceiver circuitry 706 may be instantiated by programmable circuitry such as the example programmable circuitry 1212 of FIG. 12. For instance, the neural network transceiver circuitry 706 may be instantiated by the example microprocessor 1300 of FIG. 13 executing machine executable instructions such as those implemented by at least blocks 904 of FIG. 9 and 1116 of FIG. 11. In some examples, neural network transceiver circuitry 706 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the neural network transceiver circuitry 706 may be instantiated by any other combination of hardware, software, and/or firmware. For example, the neural network transceiver circuitry 706 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the orchestrator node circuitry 700 includes means for processing neural network data. For example, the means for processing neural network data may be implemented by neural network processor circuitry 708. In some examples, the neural network processor circuitry 708 may be instantiated by programmable circuitry such as the example programmable circuitry 1212 of FIG. 12. For instance, the neural network processor circuitry 708 may be instantiated by the example microprocessor 1300 of FIG. 13 executing machine executable instructions such as those implemented by at least blocks 906 and 910 of FIG. 9. In some examples, the neural network processor circuitry 708 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the neural network processor circuitry 708 may be instantiated by any other combination of hardware, software, and/or firmware. For example, the neural network processor circuitry 708 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the orchestrator node circuitry 700 includes means for causing the first device to perform data reduction. For example, the means for causing may be implemented by network interface circuitry 702. In some examples, the orchestrator node circuitry 700 includes means for performing data reduction. For example, the means for performing data reduction may be implemented by data reduction circuitry 710. In some examples, the data reduction circuitry 710 may be instantiated by programmable circuitry such as the example programmable circuitry 1212 of FIG. 12. For instance, the data reduction circuitry 710 may be instantiated by the example microprocessor 1300 of FIG. 13 executing machine executable instructions such as those implemented by at least blocks 908 of FIG. 9 and blocks 1010, 1012, 1014, 1016, 1018, 1020 of FIG. 10. In some examples, the data reduction circuitry 710 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the data reduction circuitry 710 may be instantiated by any other combination of hardware, software, and/or firmware. For example, the data reduction circuitry 710 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the orchestrator node circuitry 700 includes means for determining network bandwidth. For example, the means for determining network bandwidth may be implemented by bandwidth sensor circuitry 712. In some examples, the bandwidth sensor circuitry 712 may be instantiated by programmable circuitry such as the example programmable circuitry 1212 of FIG. 12. For instance, the bandwidth sensor circuitry 712 may be instantiated by the example microprocessor 1300 of FIG. 13 executing machine executable instructions such as those implemented by at least block 1004 of FIG. 10. In some examples, bandwidth sensor circuitry 712 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the bandwidth sensor circuitry 712 may be instantiated by any other combination of hardware, software, and/or firmware. For example, the bandwidth sensor circuitry 712 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the orchestrator node circuitry 700 includes means for determining neural network inference accuracy. For example, the means for determining neural network inference accuracy may be implemented by accuracy sensor circuitry 714. In some examples, the accuracy sensor circuitry 714 may be instantiated by programmable circuitry such as the example programmable circuitry 1212 of FIG. 12. For instance, the accuracy sensor circuitry 714 may be instantiated by the example microprocessor 1300 of FIG. 13 executing machine executable instructions such as those implemented by at least block 1014 of FIG. 10. In some examples, the accuracy sensor circuitry 714 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the accuracy sensor circuitry 714 may be instantiated by any other combination of hardware, software, and/or firmware. For example, the accuracy sensor circuitry 714 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the orchestrator node circuitry 700 includes means for estimating neural network processing power. For example, the means for estimating neural network processing power may be implemented by power estimation circuitry 716. In some examples, the power estimation circuitry 716 may be instantiated by programmable circuitry such as the example programmable circuitry 1212 of FIG. 12. For instance, the power estimation circuitry 716 may be instantiated by the example microprocessor 1300 of FIG. 13 executing machine executable instructions such as those implemented by at least blocks 1102 and 1104 of FIG. 11. In some examples, power estimation circuitry 716 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the power estimation circuitry 716 may be instantiated by any other combination of hardware, software, and/or firmware. For example, the power estimation circuitry 716 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the orchestrator node circuitry 700 includes means for serializing. For example, the means for serializing may be implemented by serialization circuitry 718. In some examples, the serialization circuitry 718 may be instantiated by programmable circuitry such as the example programmable circuitry 1212 of FIG. 12. For instance, the serialization circuitry 718 may be instantiated by the example microprocessor 1300 of FIG. 13 executing machine executable instructions such as those implemented by at least blocks 1114 and 1118 of FIG. 11. In some examples, the serialization circuitry 718 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the serialization circuitry 718 may be instantiated by any other combination of hardware, software, and/or firmware. For example, the serialization circuitry 718 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the orchestrator node circuitry 700 of FIGS. 6A-6B is illustrated in FIG. 7, one or more of the elements, processes, and/or devices illustrated in FIG. 7 may be combined, divided, re-arranged, omitted, eliminated, and/or implemented in any other way. Further, the example network interface circuitry 702, the example network topology circuitry 704, the example neural network transceiver circuitry 706, the example neural network processor circuitry 708, the example data reduction circuitry 710, the example bandwidth sensor circuitry 712, the example accuracy sensor circuitry 714, the example power estimation circuitry 716, and the example serialization circuitry 718, and/or, more generally, the example orchestrator node circuitry 700 of FIG. 7, may be implemented by hardware alone or by hardware in combination with software and/or firmware. Thus, for example, any of the example network interface circuitry 702, the example network topology circuitry 704, the example neural network transceiver circuitry 706, the example neural network processor circuitry 708, the example data reduction circuitry 710, the example bandwidth sensor circuitry 712, the example accuracy sensor circuitry 714, the example power estimation circuitry 716, and the example serialization circuitry 718, and/or, more generally, the example orchestrator node circuitry 700, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example orchestrator node circuitry 700 of FIG. 7 may include one or more elements, processes, and/or devices in addition to, or instead of, those illustrated in FIG. 7, and/or may include more than one of any or all of the illustrated elements, processes and devices.

Flowchart(s) representative of example machine readable instructions, which may be executed by programmable circuitry to implement and/or instantiate the orchestrator node circuitry 700 of FIG. 7 and/or representative of example operations which may be performed by programmable circuitry to implement and/or instantiate the orchestrator node circuitry 700 of FIG. 7, are shown in FIGS. 9, 10, and/or 11. The machine readable instructions may be one or more executable programs or portion(s) of one or more executable programs for execution by programmable circuitry such as the programmable circuitry 1212 shown in the example programmable circuitry platform 1200 discussed below in connection with FIG. 12 and/or may be one or more function(s) or portion(s) of functions to be performed by the example programmable circuitry (e.g., an FPGA) discussed below in connection with FIGS. 13 and/or 14. In some examples, the machine readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9, 10, and/or 11, many other methods of implementing the example orchestrator node circuitry 700 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9, 10, and/or 11 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is an image representation of a neural network inference performed by the example neural network processor circuitry 708 (FIG. 7) of the example one of the compute nodes 604 (FIGS. 6A-6B). In some examples, the neural network inference is performed at a data center.

The edge network which processes the example raw data 802 is based on compute resources being placed in smaller data centers or compute locations compared to traditional centralized data centers. The compute is placed at relatively smaller data centers due to new transport technologies (e.g., 5G) or fabrics.

The Autonomous Mobile Robots of the edge network have particular (e.g., individualized) characteristics in terms of power, compute capacity and network connectivity. The example AMRs are at the relatively lower range of compute based on the resource constraint. The orchestrator node circuitry 700 executed on the AMR will, in some examples, decide to send the data from a sensor for remote inference either to reduce inference time, save electrical power, and/or possibly deploy a more sophisticated mode.

In some examples, in addition to transmitting the data, the AMR with orchestrator node circuitry 700 generates a manifest that includes information about the data type (e.g., audio data, video data, and/or lidar data, etc.), inference metadata, and latency budget. In such examples, the compute nodes 604 also generate a subsequent manifest that includes information about the data type, inference metadata, and latency budget. However, in other examples, the orchestrator node 602 generates the manifest. In such examples, the AMR merely transmits the data to the first compute node 604A of the edge network.

In some examples, the network interface circuitry 702 invokes the network topology circuitry 704 in response to a completion of one layer of a multi-layer NN. The network topology circuitry 704 is able to determine dynamic changes in the edge network during workload processing. The network topology circuitry 704 is able to consider additional nodes and alternate nodes that are available to assist in workload execution. Rather than running through all the layers of the NN, some examples disclosed herein establish a topology search. In some examples, the topology search is triggered after each particular layer of a NN is performed so that dynamic opportunities of an Edge network can be taken advantage of in a more efficient manner.

The information in the manifest regarding the inference metadata may include a recipe or the inference serving node. For example, the information regarding the inference metadata may include the workload to be used. In some examples, the workload to be used is decided by the AMR. In other examples, the workload to be used is decided by the orchestrator node 602 (e.g., fleet manager). In some examples, the inference metadata may include the number of layers of the neural network, and the next layer to be computed in the neural network.

The information in the manifest regarding the latency budget may include different latencies (represented in time) for different cameras and/or data streams. For example, a 4K camera that is operating at thirty frames per second may have a latency budget of thirty milliseconds.

The example orchestrator node 602 (FIG. 6) routes the data through the network topology. At ones of the compute nodes 604, the manifest is analyzed resulting in an action such as compute a layer of the DNN or a subgraph of a GNN. The example orchestrator node 602 decides on the routing, based on the knowledge of the available compute resources along the network route, and prioritizes the network routing based on the remaining latency budget. As the orchestrator node 602 routes the data through the edge network, by the time the data reaches an example edge server, there are less layers to compute, because the various compute nodes 604 performed inference on some of the layers. Therefore, due to the fewer layers to compute at an edge server, fewer resources are required at the server and the latency requirements are achieved.

The Autonomous Mobile Robots of the edge network have particular characteristics in terms of power, compute capacity and network connectivity. For example, regarding power availability, the AMRs are powered with batteries. Hence, the power is to be utilized in a more judicious manner as compared to edge resources that have hard-wired power connectivity. The importance of the compute task (e.g., critical task or not critical task) is factored into the AMR power consumption.

For example, regarding compute requirements, the tasks that the AMRs are to perform have particular compute requirements as well as different service level objective (e.g., a latency to make a decision based on the processing of a given payload). In some examples the payload may be based on image data or sensor data. Therefore, in connection with power availability, the compute requirements are factored into determining what computation is to occur and where the computation is to occur. For instance, while an AMR may acquire an amount of sensor data (e.g., image data containing people, obstacles, etc.), compute requirements to process such sensor data may consume substantial amounts of limited battery power. As such, in some examples, the network interface circuitry 702 offloads the sensor data to be processed at one or more available adjacent nodes that have the requisite computational capabilities and/or hardwired line power.

For example, regarding network connectivity, the AMRs have dynamic network connectivity that may change latency and bandwidth over time to the next tiers of compute (e.g., compute nodes 604 (FIG. 6) of the edge network). Therefore, the AMR determines power availability, compute requirements and network status to decide where the tasks are to be computed.

For example, regarding workload context (e.g., workload characteristics), the compute is not constant and depends on the actual context that surrounds the AMR. For instance, if the example AMR is performing person safety detection, and the pipeline used to perform the workloads is composed by two stages (one for detection and one for identification), the compute load will depend on the number of persons/objects that are in the location at that particular point in time and the number of frames per second. Hence, the workload context will have to be factored with power availability, compute requirements, and network connectivity.

In addition to the requirements of the AMRs and the edge network, there are considerations regarding the bandwidth intensive applications. For example, the bandwidth intensive applications (e.g., AI applications) generate large output size from the NN layers consuming high input/output (e.g., I/O) bandwidth. These bandwidth intensive applications require large amounts of network bandwidth to transfer data. In some examples, compute intensive applications (e.g., convolutional neural networks or residual neural networks, etc.) are typically completed in the data center, and inference is executed at edge base stations. For example, the inference in such applications occurs across several stages of convolution and pooling, as shown in FIG. 8.

In other examples, the neural network inference is executed at the edge network 600 (FIGS. 6A-6B) (e.g., edge devices, edge base stations, edge nodes, etc.). In such examples, the inference occurs across several states of convolution and pooling. In the example of FIG. 8, there are three stages of pooling (e.g., “POOL”) and five stages of convolution (e.g., “CONV”). The neural network processor circuitry 708 (FIG. 7) performs inference with an example first neural network (NN) layer 804 on example raw data 802. In some examples, the raw data 802 is a data stream that is generated from an autonomous mobile robot (AMR). For example, the AMR may include four cameras that have a resolution of two megapixels (MP). The four cameras of the AMR may operate at thirty frames per second (e.g., eight megapixels multiplied by thirty frames is two hundred and forty megapixels per second). In some examples, LiDAR data is also streamed with the camera data. However, most commercial warehouses include more than one AMR, which results in high network traffic (e.g., bandwidth) on the Wi-Fi or 5G access point for the data stream.

After the example neural network processor circuitry 708 performs convolution at the first NN layer 804, the raw data 802 has been transformed into first partially processed data 806 (e.g., intermediate results, intermediate outputs) at the pooling stage. The example network topology circuitry 704 (FIG. 7) determines if other compute nodes 604 (FIGS. 6A-6B) are available to process the first partially processed data 806 with an example second NN layer 808, to transform the example first partially processed data 806 into example second partially processed data 810. As described above, completion of the first layer of the example NN causes the network interface circuitry 702 to trigger a re-assessment of the network topology, thereby facilitating an opportunity to perform workload execution in a more efficient manner. In some examples, the network topology circuitry 704 performs the reassessment of the network topology.

After the first partially processed data 806 is transmitted to the second compute node 604B (FIGS. 6A-6B) of the combination of compute nodes 604, the second compute node 604B (FIGS. 6A-6B) performs the neural network inference. The network topology circuitry 704 of the second compute node 604B (FIGS. 6A-6B) determines that the network topology of the edge network has changed and that an example third compute node 604C (FIGS. 6A-6B) is now unavailable for processing and that an example fifth compute node 604E (FIGS. 6A-6B) is now available for processing.

In the example of FIG. 8, the second partially processed data 810 is transmitted to an example fourth compute node 604D (FIGS. 6A-6B) which begins neural network inference with an example third NN layer 812. The example fourth compute node 604D (FIGS. 6A-6B) continues to perform the neural network inference with an example fourth NN layer 814 and an example fifth NN layer 816 before the second partially processed data 810 has been processed into example third partially processed data 818.

In the example of FIG. 8, the neural network processor circuitry 708 finalizes the third partially processed data 818 into example processed data 820.

One example objective while running an inferencing application at the AMR is to be able to finish the overall execution as soon as possible, with the lowest possible latency, while factoring in the power availability, the compute requirements, the network connectivity, the workload context, and the neural network. The neural network that is built on the training data is multi-stage (e.g., multiple stages of pooling and convolution). The compute requirement and the bandwidth requirements varies based on the different stages. For example, there is no “one size fits all” partition of these stages for at least two reasons. The first reason is that the stages themselves depend on the training data and the neural network that is built. For example, the specific sizing and load information is a requirement to make decisions on what workloads can be executed which compute nodes 604 (FIG. 6). The specific sizing and load information is typically not known a priori. The second reason is that the load and ambient conditions in the edge platform can cause the compute capability to vary across a wide range. For example, different edge devices have different compute availabilities at different times.

For example, depending on the latency requirements, the compute requirements for the various stages of the neural network and the status of the different hops of the edge network, the orchestrator node 602 (FIG. 2) is to do better regarding placement of the compute which potentially enhances the battery life of the AMR. In addition, the compute design of the AMR may be simplified as the compute is placed in the edge network.

Example techniques disclosed herein adapt the existing platform resources in an agile and intelligent way rather than strict modification of the requirements. Some modifications of the requirements, in response to a target latency that is not achieved include (i) increasing the network bandwidth, (ii) increasing compute resources of an end point, edge server, or edge device, (iii) reducing resolution of sensor data, (iv) reducing frame rate, etc. Example techniques disclosed herein do not increase system cost, and/or reduce accuracy to meet the latency requirements.

The techniques disclosed herein allow for an architecture of choice from the devices, network, and Edge. In some examples, the use of the accelerator (VPU, iGPU, FPGA) is incorporated in using the techniques disclosed herein. The techniques disclosed herein meet customer needs for time-sensitive workloads at the Edge (e.g., the AMRs) of the edge network. Furthermore, the techniques disclosed herein allow for hierarchical artificial intelligence processing across the edge network topology.

A first example test is to determine if a device is using the orchestrator node circuitry 700 is to change the network topology of the potentially infringing device and observe if the total latency results change. A second example test to determine a device is using the orchestrator node circuitry 700 is to analyze the data received at the edge server and determine if the data is the same as the sensor data of the AMR or the same as the transmitted data. Other example tests to determine if a device is using the orchestrator node circuitry 700 exist.

FIG. 9 is a flowchart representative of example machine readable instructions and/or example operations 900 that may be executed, instantiated, and/or performed by programmable circuitry to implement the orchestrator node circuitry 700 of FIG. 7 to direct transmission of data between network-connected devices. The example machine-readable instructions and/or the example operations 900 of FIG. 9 begin at block 902, at which the network topology circuitry 704 determines a first network topology. For example, the network topology circuitry 704 (FIG. 7) may determine the first network topology by probing the edge network 600 (FIGS. 6A-6B) with discovering messages. The bandwidth sensor circuitry 712 is to determine the availability of the current compute node of the compute nodes 604 (FIGS. 6A-6B) which is detectable by the probe sent by a second compute node 604B (FIGS. 6A-6B). In some examples, discovery messages transmitted by the example network topology circuitry 704 include a request for recipients of the discovery message to transmit different types of return data. Return data includes, but is not limited to device identifier (ID) information, device capability information, device battery state information, and device availability information. The example network topology circuitry 704 groups responses from the transmitted discovery message(s) as a combination of devices that are candidates for participating in workload processing (e.g., processing workload data with a NN).

At block 904, the example neural network (NN) transceiver circuitry 706 is to identify a neural network (NN) to a first device of a first combination of devices. For example, the example NN transceiver circuitry 706 is to identify the NN to a first edge device (e.g., the first compute node 604A) of the edge network 600 (FIGS. 6A-6B) by using the network interface circuitry 702 (FIG. 7). In some examples, the network interface circuitry 702 identifies and/or otherwise transmits (or causes transmission of) the NN to the first device of the first combination of devices. In some examples, the NN transceiver circuitry 706 transmits an identifier to the first device (e.g., the first compute node 604A) and the first device uses the identifier to retrieve (e.g., access) portions of the neural network. In such examples, the neural network is stored in a data center. The first combination of devices (e.g., plurality of nodes) is the group of connected devices that are available for processing at a first time. In some examples, the NN transceiver circuitry 706 transmits the NN to the first device of the first combination of devices. In such examples, the NN transceiver circuitry 706 transmits a portion of the NN to the first device in response to determining whether the first device is capable of potentially completing subsequent portions of the NN. For example, if the network topology circuitry 704 determines that the first device exhibits computing capabilities that are limited to relatively simple tasks, the NN transceiver circuitry 706 may conserve network transmission bandwidth by only transmitting a particular portion of the NN that the first device can process. Stated differently, if the first device is not capable of performing tasks beyond a first portion of the NN, then transmission of the complete NN is wasteful by unnecessarily consuming network bandwidth.

At block 906, the example network interface circuitry 702 is to cause the first device to process data with a first portion of the NN 800 (FIG. 8). For example, the neural network processor circuitry 708 is to cause the first device (e.g., first compute node 604A) to begin neural network inference on the raw data 802 (FIG. 8) or to begin the neural network inference on the first partially processed data 806 (FIG. 8). The example network interface circuitry 702 may transmit an instruction to the first device to begin processing. The example neural network processor circuitry 708 executed on the first compute node 604A performs the processing of the data, but the network interface circuitry 702 of the orchestrator node 602 causes the first compute node 604A to begin processing. In some examples, the first portion of the NN refers to at least one layer of the NN 800 (FIG. 8).

At block 908, the network interface circuitry 702 is to, in some examples, cause the first device to perform data reduction. For example, the network interface circuitry 702 is to cause the first compute node 604A (e.g., first device) to perform data reduction by sending an instruction to the network interface circuitry 702 of the first compute node 604A (e.g., first device). After the first compute node 604A receives the instruction, the first compute node 604A may use the data reduction circuitry 710 to perform data reduction. The instructions 908 and the data reduction circuitry 710 are further described in connection with FIG. 10.

At block 910, the network interface circuitry 702 is to cause a second device of a second combination of devices to process data with a second portion of the NN. For example, the network interface circuitry 702 may cause the second device (e.g., a second compute node 604B) to process the data with a second portion of the NN 800 by first determining that the network topology corresponds to a second combination of devices that is different than the first combination of devices. The example network interface circuitry 702 then causes the first compute node 604A to transmit the data to the second compute node 604B. The network interface circuitry 702 may transmit an instruction to the second compute node 604B to perform neural network inference on the intermediate results (e.g., first partially processed data 806 of FIG. 8 or the second partially processed data 810 of FIG. 8) received from the first compute node 604A. For example, the second portion of the NN 800 is plurality of layers that occur after the plurality of layers that correspond to the first portion of the NN 800.

For example, if the first compute node 604A performs NN inference with the first three layers of the NN 800, then the second compute node 604B begins NN inference on the next layer of the NN 800, which is the fourth layer in this example. In this example, the first three layers of the NN 800 correspond to the first portion of the NN 800, and the fourth layer corresponds to the second portion of the NN 800. After block 910, the instructions 900 end or, in some examples, reiterate at block 902 in response to the network interface circuitry 702 detecting another workload request.

FIG. 10 is a flowchart representative of example machine readable instructions and/or example operations 908 that may be executed, instantiated, and/or performed by programmable circuitry to implement the data reduction circuitry 710 of the orchestrator node circuitry 700 of FIG. 7 to determine if the compute node is to use one or more data reduction functions. The example machine-readable instructions and/or the example operations 908 of FIG. 10 begin at block 1002, at which the network topology circuitry 704 retrieves (e.g., accesses, determines, calculates etc.) network telemetry information. For example, the network topology circuitry 704 may determine the network telemetry by probing the network topology and receiving network communications from the edge network 600 (FIGS. 6A-6B). Some example metrics corresponding to the network telemetry include a network bandwidth (block 1004), a network latency (block 1006), and a likelihood threshold (block 1008), in which respective ones of the devices from the edge network provide such metrics information in response to discovery messages. As such, the example network topology circuitry 704 aggregates metrics from devices to calculate and/or otherwise determine the network telemetry information. In response to any of the example elements of the network telemetry not satisfying a particular threshold, control flows to block 1010. However, in response to the three example elements of the network telemetry satisfying the corresponding thresholds, control flows to block 1024.

At block 1004, the bandwidth sensor circuitry 712 determines if a network bandwidth bottleneck is present. For example, in response to the bandwidth sensor circuitry 712 determining that a network bandwidth bottleneck is present (e.g., “YES”), control advances to block 1010.

Alternatively, in response to the bandwidth sensor circuitry 712 determining that a network bandwidth bottleneck is not present (e.g., “NO” at block 1004), control may advance to block 1024 depending on the results of blocks 1006 and 1008 (e.g., if both decision blocks 1006, 1008 generate a result of “NO,” then control advances to block 1024). In some examples, the bandwidth sensor circuitry 712 determines if a network bandwidth bottleneck is present by probing a 5G network and/or a Wi-Fi access point to determine the availability for network communications and transmission of data to other edge nodes in the edge network. In some examples, the bandwidth sensor circuitry 712 determines whether an SLA latency bottleneck based on current network and/or infra telemetry is likely to exist. In other examples, the bandwidth sensor circuitry 712 determines whether an edge fabric (e.g., mesh of connections between edge devices) has a congestion problem that may be alleviated with payload reduction.

At block 1006, the network topology circuitry 704 determines if a latency bottleneck is present. For example, in response to the network topology circuitry 704 determining that a latency bottleneck is present (e.g., “YES”), control advances to block 1010. Alternatively, in response to the network topology circuitry 704 determining that a latency bottleneck is not present (e.g., “NO”), control may advance to block 1024 depending on the results of blocks 1004 and 1008 (e.g., if both decision blocks 1004, 1008 generate a result of “NO,” then control advances to block 1024). In some examples, the network topology circuitry 704 is to determine if a latency bottleneck is present by determining a response time (e.g., or an average of two or more response time values) when probing the edge network.

At block 1008, the network topology circuitry 704 is to determine if a likelihood (e.g., percentage value) that the latency requirement (e.g., latency SLA) is not met for the edge network exceeds (e.g., satisfies) a threshold. For example, in response to the network topology circuitry 704 determining that a network bandwidth bottleneck is present (e.g., “YES”), control advances to block 1010. Alternatively, in response to the network topology circuitry 704 determining that a network bandwidth bottleneck is not present (e.g., “NO”), control may advance to block 1024 depending on the results of blocks 1006 and 1008 (e.g., if both decision blocks 1006, 1008 generate a result of “NO,” then control advances to block 1024). For example, the network topology circuitry 704 may determine that the likelihood that the latency SLA is not met, based on a comparison of prior latency SLA data.

In response to a “YES” from any of the decision blocks 1004, 1006, 1008, control advances to block 1010. In response to a “NO” from all the decision blocks 1004, 1006, 1008, control advances to block 1024.

At block 1010, the example data reduction circuitry 710 performs a lookup for a transformation function for the edge network service. For example, the data reduction circuitry 710 may perform a lookup for a transformation function for the edge network service by searching a database for a transformation function that keeps the SLA compliant to the edge network service and the payload. In some examples, the SLA may be metadata. In other examples, the SLA is determined in a prior network hop. Control advances to block 1012.

At block 1012, the data reduction circuitry 710 executes the transformation function on the payload. For example, the data reduction circuitry 710 may execute the transformation on the payload and determine the effect that reducing the payload has on the network telemetry (e.g., network bandwidth) and the SLA (e.g., accuracy SLA, latency SLA, battery power SLA, etc.). Control advances to block 1014.

At block 1014, the data reduction circuitry 710 determines if the execution of the transformation function on the payload achieves the network telemetry goal and SLA goal. For example, in response to the data reduction circuitry 710 determining that the execution of the transformation function on the payload achieves the network telemetry and SLA goals/objectives (e.g., “YES”), control advances to block 1022. Alternatively, in response to the data reduction circuitry 710 determining that the execution of the transformation function on the payload did not achieve the network telemetry and SLA (e.g., “NO”), control advances to block 1016. For example, the data reduction circuitry 710 may determine if the execution of the transformation function on the payload reduced the payload of the network packet such that the network packet may propagate in the network and achieve the network SLA. For example, the data reduction circuitry 710 may determine if the execution of the transformation function on the payload reduced the payload of the network packet such that the bandwidth estimated to be used by the network packet is reduced. In some examples, the SLA is metadata. In other examples, the SLA is previously recorded and known in the hop with prior registration.

At block 1016, in response to the execution of the transformation execution not achieving the network telemetry and SLA, the example data reduction circuitry 710 determines if the network packet achieves the SLA despite not reducing network burden. In response to the example data reduction circuitry 710 not reducing the network burden, (e.g., “NO”), control advances to block 1018. Alternatively, in response to the example data reduction circuitry 710 reducing the network burden, (e.g., “YES”), control advances to block 1024. For example, the data reduction circuitry 710 may determine the network packet achieves the SLA by requesting an indication from the example network topology circuitry 704 which determines if the latency SLA is achieved. In other examples, the data reduction circuitry 710 may determine the network packet achieves the SLA by the requesting an indication from the example accuracy sensor circuitry 714 to determine if the data was reduced to an acceptable threshold that allows for an accuracy of a threshold. In some examples, the data reduction circuitry 710, based on current network bandwidth utilization, applies the minimum transformation function that allows the network payload to achieve the latency SLA while reducing the maximum of the accuracy SLA as little as possible.

At block 1018, the data reduction circuitry 710 evaluates what SLA can be achieved based on the transformation function. For example, the data reduction circuitry 710 may evaluate the SLA by referring to prior latencies regarding similar network packets. In some examples, the data reduction circuitry 710 performs deep packet inspection to determine (e.g., learn, uncover) the SLAs. For example, the data reduction circuitry 710 performs deep packet inspection by determining metadata in the packets. Control advances to block 1020.

At block 1020, the data reduction circuitry 710 executes the transformation function on the payload of the network packet. For example, the data reduction circuitry 710 may execute the transformation function circuitry which reduces the data by removing redundant frames from video streams. In some examples, the data reduction circuitry 710 may execute the transformation function by removing data that does not have additional information compared to previous (e.g., last) received data. Control advances to block 1022.

At block 1022, the data reduction circuitry 710 updates the payload for the network packet. For example, the data reduction circuitry 710 may update the payload for the network packet based on the reduced data. Control advances to block 1024.

At block 1024, the data reduction circuitry 710 allows the network packet to continue. For example, the data reduction circuitry 710 may allow the network packet (which has the reduced payload) to continue for neural network inference conducted by the first compute node 604A or for the network packet to continue to the second compute node 604B for neural network inference conducted by the second compute node 604B. The instructions 908 return to block 910 of FIG. 9.

In some examples, a reduction function utilized in a smart city analytics use case could be based on a first small and simple neural network that is applied to the current frame captured by a camera. The example first small and simple neural network detects the number of persons detected within the frame. In some examples, the data reduction circuitry 710 decides to drop the frame if the bandwidth available on the network is between five and ten gigabytes per second (e.g., “Gbps”) and the number of persons that is detected is below ten. In such examples, the data reduction circuitry 710 decides to drop the frame if the bandwidth available on the network is between ten and fifteen gigabytes per second (e.g., “Gbps”) and the number of persons that is detected is below five. For example, the data reduction circuitry 710 drops the frame when the number of people is less.

In some examples, in each of the stages of the neural network as executed by the neural network processor circuitry 708, the amount of input data and the output data is reduced by an order of magnitude. Therefore, depending on the number of convolutions, the data reduction may be substantial. However, this data reduction is associated with a relatively greater amount of compute requirements. The example orchestrator node 602 determines a usage case and a training-stage data specific neural network (e.g., offload engine). The example neural network is transmitted along with the trained neural network model after the training stage. In some examples, the infrastructure at the edge (e.g., the AMRs, the compute nodes 604) uses the usage case and the training-stage data specific to make offload decisions on how neural network inferencing can be partitioned between the edge and the datacenter.

The techniques disclosed herein used the data size reduction functions that proactively transform what is injected into the pipe based on the service level agreement of services consuming data (e.g., accuracy and latency) with respect to the network utilization (e.g., network telemetry, network topology). In some examples, the reduction functions are provided based on the service or the service type. In some examples, the reduction function may be an entropy function that includes conditionality and temporality of the reduction function. Therefore, different SLAs may be defined in percentual way. In some examples, the reduction function used by the data reduction circuitry 710 is from the perspective of the AMR. In other examples, the reduction function used by the data reduction circuitry 710 is from the perspective of the orchestrator node 602 or the compute nodes 604.

In some examples, an input for the reduction function is defined by (i) a service ID associated to the reduction function, (ii) a sensor associated to the reduction function, and (iii) a function elements breakdown. In some examples, the function elements breakdown is defined as a list of (i) an SLA value (e.g., accuracy of 80%) and (ii) a percentage of time (e.g., 80% of the time) that the SLA value is to be achieved.

For example, for a surveillance use case with different resolutions (e.g., 1080 pixels, 720 pixels) and an SLA of eighty percent for eighty percent of the time, the data reduction circuitry 710 changes the entropy of the image, which affects the accuracy of the neural network inference. Therefore, if the SLA for this service is a minimum of eighty percent accuracy, the data reduction circuitry 710 changes the resolution up to the point that accuracy is greater than or equal to eighty percent. In some examples, these thresholds can be estimated offline with benchmarking.

In some examples, the data reduction circuitry 710 uses complex reduction functions. For example, the orchestrator node 602 decides the resolution that is needed depending on the density of objects in the content (e.g., the number of objects or person and region of interests detected within a frame). Therefore, the higher number of persons or objects corresponds to a higher resolution. Determining the resolution is a new way to determine data transfer. FIG. 10 provides a description of the reduction function flow on that may executed at AMR device level. In some examples, the reduction functions and transformation functions could be applied in any hop from the data source (e.g., either the AMR or the first compute node 604A) to the target service (e.g., edge network).

FIG. 11 is a flowchart representative of example machine readable instructions and/or example operations 1100 that may be executed, instantiated, and/or performed by programmable circuitry to implement the orchestrator node circuitry 700 of FIG. 7 to determine if the compute node is to transmit data to another compute node. The example machine-readable instructions and/or the example operations 1100 of FIG. 11 begin at block 1102, at which the power estimation circuitry 716 estimates the power to compute a first number of neural network (NN) layers locally at the first compute node 604A (FIGS. 6A-6B). For example, the power estimation circuitry 716 may estimate the power required to compute a first number of neural network (NN) layers locally at the first compute node 604A (FIGS. 6A-6B) in response to an instruction from the example network interface circuitry 702. In some examples, the example first compute node 604A is a battery-powered edge device and thus, battery power conservation is important. Control advances to block 1104.

At block 1104, the power estimation circuitry 716 estimates the power to send intermediate output data that would be generated by a second number of NN layers. For example, the power estimation circuitry 716 may estimate the power to send intermediate output data that would be generated by a second number of NN layers by accessing a network topology with the network topology circuitry 704 based on the latency. Control advances to block 1106.

At block 1106, the neural network processor circuitry 708 determines the number of NN layers to execute locally based on the estimations. For example, the neural network processor circuitry 708 may determine the number of NN layers to execute locally based on the local power estimation and the transmission power estimation. Based on (A) the power estimation, (B) the transmission power estimation and (C) the SLA provided by the AMR (e.g., request originator), the neural network processor circuitry 708 identifies the specific (e.g., particular) layer and/or set of layers that are to be executed (e.g., layer X to layer Y). In some examples, the particular layer to execute is based on a relative comparison of other layers. For example, the neural network processor circuitry 708 selects the layer that satisfies the relatively highest or lowest capability (e.g., the third layer consumes the least power when compared to the first, second, fourth, and fifth layers).

In some examples, the power estimated to be consumed in performing a first layer of NN inference locally on the first compute node 604A may be less than the power estimated to be consumed in performing three layers of NN inference locally on the first compute node 604A. However, the power to perform two layers of NN inference locally on the first compute node 604A and send the intermediate output data to a second compute node 604B, where the second compute node 604B is to perform a third layer of NN inference may be more than the power to perform one layer of NN inference locally on the first compute node 604A and send the intermediate outputs to a second compute node 604B, where the second compute node 604B is to perform at least one layer of NN inference. In some examples, the second compute node 604B is a particular distance away from the first compute node 604A, such that the power to transmit the serialized outputs is more than the power for the first compute node 604A to perform the NN inference. Control advances to block 1108.

At block 1108, the neural network processor circuitry 708 executes the determined number of NN layers locally. For example, the neural network processor circuitry 708 may execute the determined number of NN layers locally in accordance with FIG. 8. In some examples, the neural network processor circuitry 708 executes the layers starting at layer X through layer Y. Control advances to block 1110.

At block 1110, the neural network processor circuitry 708 collects (e.g., compacts) the intermediate output generated by neurons of the NN. For example, the neural network processor circuitry 708 may collect the intermediate output generated by neurons of the NN as partially-processed results. In some examples, the neural network processor circuitry 708 collects the intermediate output generated by neurons of layer Y as partially-processed results. In some examples, the neural network processor circuitry 708 requests the network interface circuitry 702 to send the collected intermediate results to a next level of aggregation. Control advances to block 1112.

At block 1112, the neural network processor circuitry 708 stores the intermediate output in a temporary buffer 722 using an identification key. Control advances to block 1114.

At block 1114, the serialization circuitry 718 serializes the intermediate outputs. For example, the serialization circuitry 718 may serialize the intermediate outputs by transforming (e.g., encoding) the intermediate outputs into a format that is readable (e.g., decodable) by the second compute node 604B. Control advances to block 1116.

At block 1116, the neural network transceiver circuitry 706 transmits the identification key, a NN identifier that corresponds to the NN used by the first compute node 604A, the serialized intermediate outputs, and an identifier that corresponds to the current layer of the NN last completed by the first compute node 604A. For example, the neural network transceiver circuitry 706 may transmit the identification key, a NN identifier that corresponds to the NN used by the first compute node 604A, the serialized intermediate outputs, and an identifier that corresponds to the current layer of the NN last completed by the first compute node 604A by using the network interface circuitry 702 to directly transmit the results to a second compute node 604B. In some examples, the NN is stored in a data center and the NN identifier is used to retrieve the NN from the data center. In some examples, the neural network transceiver circuitry 706 is implemented by the serialization circuitry 718. In other examples, the network interface circuitry 702 implements the neural network transceiver circuitry 706.

The NN transceiver circuitry 706 uses the identification key to access the correct intermediate outputs which have been collected and serialized and placed in the temporary buffer 722. In some examples, temporary buffer 722 is accessible by any of the compute nodes 604 and therefore may include numerous different intermediate outputs. The example NN transceiver circuitry 706 uses the neural network identifier (e.g., the NN identifier that corresponds to the NN used by the first compute node 604A) because, in some examples, multiple compute nodes 604 of the edge network 600 are sharing and transmitting different neural networks to the temporary buffer 722. The NN transceiver circuitry 706 uses the identifier that corresponds to the current layer of the selected neural network. For example, if the compacted, serialized intermediate results have been processed through a first layer of the neural network, beginning processing on a third layer of the correct neural network will cause an incorrect result, because the second layer of the correct neural network was skipped.

The neural network transceiver circuitry 706 transmits the four items (e.g., the identification key, the NN identifier that corresponds to the NN used by the first compute node, the serialized intermediate outputs, and the identifier that corresponds to the current layer of the NN last completed by the first compute node) to a temporary buffer 722 of a second compute node 604B. Control advances to block 1118.

At block 1118, the serialization circuitry 718 of the second compute node 604B de-serializes the serialized intermediate outputs. For example, the serialization circuitry 718 may de-serialize the serialized intermediate outputs at the second compute node 604B by decoding the serialized intermediate outputs. Control advances to block 1120.

At block 1120, the neural network processor circuitry 708 of the second compute node 604B selects the neural network to execute from a plurality of neural networks based on the NN identifier that corresponds to the NN used by the first compute node 604A. For example, the neural network processor circuitry 708 selects the neural network to execute based on the NN identifier stored in the temporary buffer 722 that was transmitted by the neural network transceiver circuitry 706 of the first compute node 604A and downloaded by the neural network transceiver circuitry 706 of the second compute node 604B. Control advances to block 1122.

At block 1122, the neural network processor circuitry 708 determines if there are more neural network layers to execute. For example, in response to the neural network processor circuitry 708 determining that there are more neural network layers to execute (e.g., “YES”), control advances to block 1102. Alternatively, in response to the neural network processor circuitry 708 determining that there are not more neural network layers to execute (e.g., “NO”), control advances to block 1124. In some examples, the neural network processor circuitry 708 determines that there are more neural network layers by comparing the number of neural network layers to the NN layer identifier.

At block 1124, the neural network processor circuitry 708 finalizes the intermediate output as a final result. For example, the neural network processor circuitry 708 may finalize the intermediate output as a final result by terminating the neural network inference. In some examples, the neural network transceiver circuitry 706 may transmit the final result back to the first compute node 604A. The instructions 1100 end.

In some examples, the computation and processing of the neural network is distributed across the compute nodes (e.g., network nodes, edge nodes) where there is a trade-off between the bandwidth that a given layer will generate as output, and the amount of compute (e.g., a number of computational cycles, a quantity of power, an amount of heat generation, etc.) that is needed to execute that layer. At a given hop of the network (e.g., transmission) both the bandwidth and the amount of compute is factored to decide whether the payload needs to continue traversing the network topology for one or more available resources or a given layer (or multiple layers) can be executed in the current hop.

In some examples, the compute nodes 604 (e.g., network nodes, edge nodes) at the edge infrastructure estimate the transmit time given the current stage of the payload. In such examples, the compute nodes 604 estimate how much bandwidth will be required if executing the current layer or the current layer and consecutive layers of the neural network. These example estimates are correlated to the amount of compute needed to compute the current layer or the current layer and consecutive layers of the NN based on the amount of compute available in the current hop.

The example network interface circuitry 702 of the orchestrator node circuitry 700 is to use telemetry sensor data in calculations and decisions. In some examples, the telemetry sensor data is provided by the orchestrator node circuitry 700 to the neural network processor circuitry 708. The telemetry sensor data includes ambient data, energy data, telemetry data and prior data. The example ambient data provides temperature and other data that can be used to better estimate how much power will be consumed by each of the layers of the neural network. The example energy data, retrieved from the power estimation circuitry 716, which determines how much energy is currently left in the battery subsystem. The example telemetry data, retrieved from the network topology circuitry 704, determines how much bandwidth is currently available for transmitting data from the edge node to the next level of aggregation in the network edge infrastructure. Additionally, prior data regarding the previous time and/or latency and the accuracy of a previous execution on a particular one of the compute nodes 604.

The neural network processor circuitry 708 includes a functionality to, during execution of the different layers of the neural network, stop execution of the neural network at any layer of the neural network. The neural network processor circuitry 708 then consolidates all outputs from the neurons of the current layer into an intermediate result. The neural network processor circuitry 708 stores the intermediate result in the temporary buffer 722 (e.g., temporary storage) with the identification of the request being processed.

The example neural network processor circuitry 708 corresponding to a first compute node 604A, in response to an instruction from an orchestrator node 602, an autonomous mobile robot, or another one of the compute nodes 604, is to execute a particular neural network with a particular identification, a particular payload with a particular (e.g., 10 megabytes), or a particular SLA that is provided in terms of a time metric (e.g., 10 milliseconds).

In some examples, the compute nodes 604 act as a community or group of nodes that accept requests as a singular entity and assign workloads to specific compute nodes 604 based on local optimization. A first advantage is that the compute nodes 604 acting as a community of nodes minimizes cases when a workload is sent to a third compute node 604C that can no longer accommodate the workload. A second advantage is that the compute nodes 604 acting as a community of nodes minimizes a likelihood of over-sending workloads to a specific compute node (such as the fourth compute node 604D) that has desirable performance (e.g., power, compute availability). Over-sending would rapidly deteriorate the desirable performance of the specific compute node.

In some examples, the compute nodes 604 assign tasks to the compute nodes 604 in a ranked fashion and downgrade the rank of the specific compute node of the compute nodes 604 that received the workload. The compute nodes 604 which assign tasks in a ranked round robin ensures load balancing.

In some examples, compute nodes 604 belonging to a group could be either based on type of node. For example, all the compute nodes 604 that have a VPU could belong to a group. In another example, all the compute nodes 604 that are based in a physical location could belong to a group. By placing the compute nodes 604 in a group based on location, the collaboration between the compute nodes 604 is increased with minimal power requirements.

In some examples, the example compute nodes 604 do not have access to an orchestrator node 602. In such examples, the compute nodes 604 are to increase the performance and computation of the workloads locally on the local edge network. There may be a relatively more efficient solution that the orchestrator node 602 is able to determine by evaluating the global edge network. The orchestrator node 602, in a centrally managed environment, determines and reserves a first set of compute nodes 604 before execution. The orchestrator node 602 (e.g., centralized server) then assigns the sequence of tasks for the reserved compute nodes 604. The orchestrator node 602 (e.g., centralized server) is available to provide alternative compute nodes 604 when reserved compute nodes 604 fail. However, in the absence of a central authority like the orchestrator node 602, the compute nodes 604 rely on the ones of the compute nodes 604 knowing a list of neighboring compute nodes 604 that are available to receive the sent workloads. Additionally and/or alternatively, the compute nodes 604 may access a directory of compute nodes available to collaborate. The directory is to be maintained by the compute nodes 604. Local optimization of workloads is useful where updating a central server is costly.

In some examples, multiple ones of the compute nodes 604 run the computation in parallel. By performing the execution of the computation in parallel, the compute nodes 604 are protected if one of the compute nodes 604 fails or breaks the latency by performing the computation too slowly. In such examples, the reliability of the first compute node 604A is a factor in determining if the first compute node 604A is available for processing.

FIG. 12 is a block diagram of an example programmable circuitry platform 1200 structured to execute and/or instantiate the example machine-readable instructions and/or the example operations of FIGS. 9, 10, and/or 11 to implement the orchestrator node circuitry 700 of FIG. 7. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, and/or microcontrollers from any desired family or manufacturer. The programmable circuitry 1212 may be implemented by one or more semiconductor based (e.g., silicon based) devices. In this example, the programmable circuitry 1212 implements the example network interface circuitry 702, the example network topology circuitry 704, the example neural network transceiver circuitry 706, the example neural network processor circuitry 708, the example data reduction circuitry 710, the example bandwidth sensor circuitry 712, the example accuracy sensor circuitry 714, the example power estimation circuitry 716, and the example serialization circuitry 718.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. The mass storage discs or devices 1228 store the example SLA database 720 and the example temporary buffer 722.

The machine readable instructions 1232, which may be implemented by the machine readable instructions of FIGS. 9, 10, and/or 11, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 9, 10, and/or 11 to effectively instantiate the circuitry of FIG. 2 as logic circuits to perform operations corresponding to those machine readable instructions. In some such examples, the circuitry of FIG. 7 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 9, 10, and/or 11.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1300, in the same chip package as the microprocessor 1300 and/or in one or more separate packages from the microprocessor 1300.

FIG. 14 is a block diagram of another example implementation of the programmable circuitry 1212 of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine readable instructions represented by the flowchart(s) of FIGS. 9, 10, and/or 11 but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 9, 10, and/or 11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 9, 10, and/or 11. As such, the FPGA circuitry 1400 may be configured and/or structured to effectively instantiate some or all of the operations/functions corresponding to the machine readable instructions of the flowchart(s) of FIGS. 9, 10, and/or 11 as dedicated logic circuits to perform the operations/functions corresponding to those software instructions in a dedicated manner analogous to an ASIC. Therefore, the FPGA circuitry 1400 may perform the operations/functions corresponding to the some or all of the machine readable instructions of FIGS. 9, 10, and/or 11 faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine readable instructions of FIGS. 9, 10, and/or 11 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 13. Therefore, the programmable circuitry 1212 of FIG. 12 may additionally be implemented by combining at least the example microprocessor 1300 of FIG. 13 and the example FPGA circuitry 1400 of FIG. 14. In some such hybrid examples, one or more cores 1302 of FIG. 13 may execute a first portion of the machine readable instructions represented by the flowchart(s) of FIGS. 9, 10, and/or 11 to perform first operation(s)/function(s), the FPGA circuitry 1400 of FIG. 14 may be configured and/or structured to perform second operation(s)/function(s) corresponding to a second portion of the machine readable instructions represented by the flowcharts of FIGS. 9, 10, and/or 11, and/or an ASIC may be configured and/or structured to perform third operation(s)/function(s) corresponding to a third portion of the machine readable instructions represented by the flowcharts of FIGS. 9, 10, and/or 11.

It should be understood that some or all of the circuitry of FIG. 7 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIG. 7 may be instantiated, for example, in one or more threads executing concurrently and/or in series. For example, the microprocessor 1300 of FIG. 13 may execute machine readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the circuitry of FIG. 7 may be implemented within one or more virtual machines and/or containers executing on the microprocessor 1300 of FIG. 13.

In some examples, the programmable circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the programmable circuitry 1212 of FIG. 12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

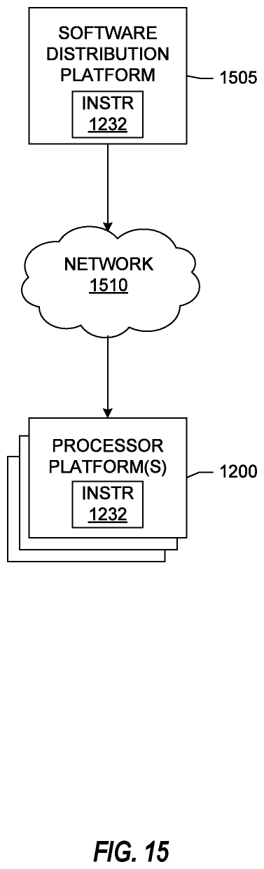

FIG. 15 is a block diagram of an example software/firmware/instructions distribution platform 1505 (e.g., one or more servers) to distribute software, instructions, and/or firmware (e.g., corresponding to the example machine readable instructions of FIGS. 9, 10, and/or 11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The example software distribution platform 1505 is to distribute software such as the example machine readable instructions 1232 of FIG. 12 to other hardware devices (e.g., hardware devices owned and/or operated by third parties from the owner and/or operator of the software distribution platform). The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions of FIGS. 9, 10, and/or 11, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions of FIGS. 9, 10, and/or 11, may be downloaded to the example programmable circuitry platform 1200, which is to execute the machine readable instructions 1232 to implement the orchestrator node circuitry 700. In some examples, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that direct transmission of data in network connected devices. By directing transmission of data in network connected devices, the techniques disclosed herein are able to determine if other compute nodes or network connected devices are available for processing a neural network based on service level agreements. Furthermore, the techniques disclosed herein are to reduce data that is transmitted between the network connected devices, while maintaining the service level agreements. Disclosed systems, apparatus, articles of manufacture, and methods improve the efficiency of using a computing device by allowing other computing devices to perform neural network processing. The techniques disclosed herein improve the efficiency of the computing device because less data is transmitted to the other computing devices so less electrical power is needed for processing at the second computing device. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to direct transmission of data between network connected devices are disclosed herein. Further examples and combinations thereof include the following: Example 1 includes an apparatus comprising interface circuitry, instructions, and programmable circuitry to at least one of instantiate or execute the instructions to cause the interface circuitry to identify a neural network (NN) to a first device of a first combination of devices corresponding to a first network topology, cause the first device to process first data with a first portion of the NN, and cause a second device of a second combination of devices to process second data with a second portion of the NN, the second combination of devices corresponding to a second network topology.

Example 2 includes the apparatus of example 1, wherein the first combination of devices is different from the second combination of devices.

Example 3 includes the apparatus of example 1, wherein the instructions are to, in response to completion of the first device processing the first data with the first portion of the NN, cause a determination that the first combination of devices is different from the second combination of devices.

Example 4 includes the apparatus of example 1, wherein the instructions are to cause a determination that the first network topology is different from the second network topology.

Example 5 includes the apparatus of example 1, wherein the devices, of the first combination of devices that correspond to the first network topology, have first compute capabilities, and the devices, of the second combination of devices that correspond to the second network topology, have second compute capabilities.

Example 6 includes the apparatus of example 5, wherein the first network topology has a first compute capability based on the first compute capabilities of the first combination of devices, and the second network topology has a second compute capability based on the second compute capabilities of the second combination of devices.

Example 7 includes the apparatus of example 1, wherein the instructions are to cause the second device of the second combination of devices to process the second data with the second portion of the NN based on a capability associated with a service level agreement (SLA).

Example 8 includes the apparatus of example 7, wherein the SLA includes at least one of a latency requirement or an accuracy requirement.

Example 9 includes the apparatus of example 8, wherein the instructions are to cause the first device to execute a data reduction function on partially-processed data from the first portion of the NN, the data reduction function to generate reduced data.

Example 10 includes the apparatus of example 9, wherein the instructions are to execute the data reduction function on the partially-processed data prior to transmitting the reduced data to the second device.

Example 11 includes the apparatus of example 1, wherein the interface circuitry is to transmit the NN to the first device.

Example 12 includes the apparatus of example 1, wherein the interface circuitry is to cause the first device to retrieve the NN, where the NN is stored in a datacenter.

Example 13 includes a non-transitory storage medium comprising instructions to cause programmable circuitry to at least identify a neural network (NN) to a first device of a first combination of devices corresponding to a first network topology, cause the first device to process first data with a first portion of the NN, and cause a second device of a second combination of devices to process second data with a second portion of the NN, the second combination of devices corresponding to a second network topology.

Example 14 includes the non-transitory storage medium of example 13, wherein the first combination of devices is different from the second combination of devices.

Example 15 includes the non-transitory storage medium of example 13, wherein the programmable circuitry is to, in response to completion of the first device processing the first data with the first portion of the NN, cause a determination that the first combination of devices is different from the second combination of devices.

Example 16 includes the non-transitory storage medium of example 13, wherein the programmable circuitry is to cause a determination that the first network topology is different from the second network topology.

Example 17 includes the non-transitory storage medium of example 13, wherein the devices, of the first combination of devices that correspond to the first network topology, have first compute capabilities, and the devices, of the second combination of devices that correspond to the second network topology, have second compute capabilities.

Example 18 includes the non-transitory storage medium of example 17, wherein the first network topology has a first compute capability based on the first compute capabilities of the first combination of devices, and the second network topology has a second compute capability based on the second compute capabilities of the second combination of devices.

Example 19 includes the non-transitory storage medium of example 18, wherein the programmable circuitry is to cause the second device of the second combination of devices to process the second data with the second portion of the NN based on a capability associated with a service level agreement (SLA).

Example 20 includes the non-transitory storage medium of example 19, wherein the SLA includes at least one of a latency requirement or an accuracy requirement.

Example 21 includes the non-transitory storage medium of example 20, wherein the programmable circuitry is to cause the first device to execute a data reduction function on partially-processed data from the first portion of the NN, the data reduction function to generate reduced data.

Example 22 includes the non-transitory storage medium of example 21, wherein the programmable circuitry is to execute the data reduction function on the partially-processed data prior to transmitting the reduced data to the second device.

Example 23 includes an apparatus comprising neural network (NN) transceiver circuitry to identify a neural network to a first device of a first combination of devices corresponding to a first network topology, and network interface circuitry to cause the first device to process first data with a first portion of the NN, and cause a second device of a second combination of devices to process second data with a second portion of the NN, the second combination of devices corresponding to a second network topology.

Example 24 includes the apparatus of example 23, wherein the first combination of devices is different from the second combination of devices.

Example 25 includes the apparatus of example 23, further including network topology circuitry, the network topology circuitry to, in response to completion of the first device processing the first data with the first portion of the NN, cause a determination that the first combination of devices is different from the second combination of devices.

Example 26 includes the apparatus of example 25, wherein the network topology circuitry is to cause a determination that the first network topology is different from the second network topology.

Example 27 includes the apparatus of example 23, wherein the devices, of the first combination of devices that correspond to the first network topology, have first compute capabilities, and the devices, of the second combination of devices that correspond to the second network topology, have second compute capabilities.

Example 28 includes the apparatus of example 27, wherein the first network topology has a first compute capability based on the first compute capabilities of the first combination of devices, and the second network topology has a second compute capability based on the second compute capabilities of the second combination of devices.

Example 29 includes the apparatus of example 28, wherein the network interface circuitry is to cause the second device of the second combination of devices to process the second data with the second portion of the NN based on a capability associated with a service level agreement (SLA).

Example 30 includes the apparatus of example 29, wherein the SLA includes at least one of a latency requirement or an accuracy requirement.

Example 31 includes the apparatus of example 30, wherein the network interface circuitry is to cause the first device to execute a data reduction function on partially-processed data from the first portion of the NN, the data reduction function to generate reduced data.

Example 32 includes the apparatus of example 31, further including data reduction circuitry, the data reduction circuitry to execute the data reduction function on the partially-processed data prior to transmitting the reduced data to the second device.

Example 33 includes the apparatus of example 23, wherein the neural network transceiver circuitry is to transmit the NN to a first device of a first combination of devices corresponding to a first network topology.

Example 34 includes the apparatus of example 23, wherein the NN is stored in a data center.

Example 35 includes an apparatus comprising means for identifying to identify a NN to a first device of a first combination of devices corresponding to a first network topology, and means for causing a device to process data, the means for causing the device to process data to cause the first device to process first data with a first portion of the NN, and cause a second device of a second combination of devices to process second data with a second portion of the NN, the second combination of devices corresponding to a second network topology.

Example 36 includes the apparatus of example 35, wherein the first combination of devices is different from the second combination of devices.

Example 37 includes the apparatus of example 35, further including means for determining a network topology, wherein the means for determining the network topology are to, in response to completion of the first device processing the first data with the first portion of the NN, cause a determination that the first combination of devices is different from the second combination of devices.

Example 38 includes the apparatus of example 37, wherein the means for determining the network topology are to cause a determination that the first network topology is different from the second network topology.

Example 39 includes the apparatus of example 35, wherein the devices, of the first combination of devices that correspond to the first network topology, have first compute capabilities, and the devices, of the second combination of devices that correspond to the second network topology, have second compute capabilities.

Example 40 includes the apparatus of example 39, wherein the first network topology has a first compute capability based on the first compute capabilities of the first combination of devices, and the second network topology has a second compute capability based on the second compute capabilities of the second combination of devices.

Example 41 includes the apparatus of example 40, wherein the means for causing the device to process data are to cause the second device of the second combination of devices to process the second data with the second portion of the NN based on a capability associated with a service level agreement (SLA).

Example 42 includes the apparatus of example 41, wherein the SLA includes at least one of a latency requirement or an accuracy requirement.

Example 43 includes the apparatus of example 42, wherein the means for causing the device to process data are to cause the first device to execute a data reduction function on partially-processed data from the first portion of the NN, the data reduction function to generate reduced data.

Example 44 includes the apparatus of example 43, further including means for performing data reduction, the means for performing data reduction are to execute the data reduction function on the partially-processed data prior to transmitting the reduced data to the second device.

Example 45 includes the apparatus of example 35, further including means for transmitting to transmit the NN to a first device of a first combination of devices corresponding to a first network topology.

Example 46 includes the apparatus of example 35, wherein the NN is stored in a data center.

Example 47 includes a method comprising identifying a NN to a first device of a first combination of devices corresponding to a first network topology, and causing the first device to process first data with a first portion of the NN, and causing a second device of a second combination of devices to process second data with a second portion of the NN, the second combination of devices corresponding to a second network topology.

Example 48 includes the method of example 47, wherein the first combination of devices is different from the second combination of devices.

Example 49 includes the method of example 47, in response to completion of the first device processing the first data with the first portion of the NN, further including causing a determination that the first combination of devices is different from the second combination of devices.

Example 50 includes the method of example 49, further including causing a determination that the first network topology is different from the second network topology.

Example 51 includes the method of example 49, wherein the devices, of the first combination of devices that correspond to the first network topology, have first compute capabilities, and the devices, of the second combination of devices that correspond to the second network topology, have second compute capabilities.

Example 52 includes the method of example 51, wherein the first network topology has a first compute capability based on the first compute capabilities of the first combination of devices, and the second network topology has a second compute capability based on the second compute capabilities of the second combination of devices.

Example 53 includes the method of example 52, further including causing the second device of the second combination of devices to process the second data with the second portion of the NN based on a capability associated with a service level agreement (SLA).

Example 54 includes the method of example 53, wherein the SLA includes at least one of a latency requirement or an accuracy requirement.

Example 55 includes the method of example 54, further including causing the first device to execute a data reduction function on partially-processed data from the first portion of the NN, the data reduction function to generate reduced data.

Example 56 includes the method of example 55, further including executing the data reduction function on the partially-processed data prior to transmitting the reduced data to the second device.

Example 57 includes the method of example 47, further including transmitting the NN to the first device.

Example 58 includes the method of example 47, wherein the NN is stored in a data center.

Example 59 includes an apparatus comprising wireless communication circuitry, instructions, and programmable circuitry to at least one of instantiate or execute the instructions to process first data with a first portion of a neural network (NN), and transmit second data to be processed by a second portion of the NN to a first peer device associated with a combination of peer devices which changed from a first combination to a second combination of peer devices.

Example 60 includes the apparatus of example 59, wherein the programmable circuitry is to determine that the combination of peer devices changed from the first combination to the second combination of peer devices.

Example 61 includes the apparatus of example 59, wherein the programmable circuitry is to process the first data with the first portion of the NN in response to receiving an instruction from an orchestrator node.

Example 62 includes the apparatus of example 59, wherein the programmable circuitry is to execute a data reduction function on the first data to generate reduced data.

Example 63 includes the apparatus of example 62, wherein the programmable circuitry is to transmit the reduced data to the first peer device.

Example 64 includes the apparatus of example 63, wherein the data reduction function is to be executed on the data that been processed through the first portion of the NN, prior to the data being transferred to the first peer device.

Example 65 includes the apparatus of example 59, wherein the programmable circuitry is to determine a first service level agreement (SLA) that corresponds to the first combination of peer devices and a second SLA that corresponds to the second combination of peer devices, the second SLA different than the first SLA.

Example 66 includes the apparatus of example 59, wherein the programmable circuitry is to determine a number of layers of the NN that remain to process the second data, and determine a first processing time that relates to locally processing the second data with the number of the layers of the NN that remain.

Example 67 includes the apparatus of example 66, wherein the programmable circuitry is to compare a second processing time to the first processing time, the second processing time corresponding to transferring the second data to the first peer device and the first processing time corresponding to locally processing the second data with the number of the layers of the NN that remain.

Example 68 includes the apparatus of example 67, wherein the programmable circuitry is to transmit the layers of the NN that remain to the first peer device.

Example 69 includes the apparatus of example 67, wherein the programmable circuitry is to instruct the first peer device to retrieve layers of the NN that remain from a data center.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
instructions; and
programmable circuitry to at least one of instantiate or execute the instructions to:
cause the interface circuitry to identify a neural network (NN) to a first device of a first combination of devices corresponding to a first network topology;
cause the first device to process first data with a first portion of the NN; and
cause a second device of a second combination of devices to process second data with a second portion of the NN, the second combination of devices corresponding to a second network topology.

2. The apparatus of claim 1, wherein the first combination of devices is different from the second combination of devices.

3. The apparatus of claim 1, wherein the instructions are to, in response to completion of the first device processing the first data with the first portion of the NN, cause a determination that the first combination of devices is different from the second combination of devices.

4. The apparatus of claim 1, wherein the instructions are to cause a determination that the first network topology is different from the second network topology.

5. The apparatus of claim 1, wherein the devices, of the first combination of devices that correspond to the first network topology, have first compute capabilities, and the devices, of the second combination of devices that correspond to the second network topology, have second compute capabilities.

6. The apparatus of claim 5, wherein the first network topology has a first compute capability based on the first compute capabilities of the first combination of devices, and the second network topology has a second compute capability based on the second compute capabilities of the second combination of devices.

7. The apparatus of claim 1, wherein the instructions are to cause the second device of the second combination of devices to process the second data with the second portion of the NN based on a capability associated with a service level agreement (SLA).

8. The apparatus of claim 7, wherein the SLA includes at least one of a latency requirement or an accuracy requirement.

9. The apparatus of claim 8, wherein the instructions are to cause the first device to execute a data reduction function on partially-processed data from the first portion of the NN, the data reduction function to generate reduced data.

10. The apparatus of claim 9, wherein the instructions are to execute the data reduction function on the partially-processed data prior to transmitting the reduced data to the second device.

11. The apparatus of claim 1, wherein the interface circuitry is to transmit the NN to the first device.

12. The apparatus of claim 1, wherein the interface circuitry is to cause the first device to retrieve the NN, where the NN is stored in a datacenter.

13. A non-transitory storage medium comprising instructions to cause programmable circuitry to at least:
identify a neural network (NN) to a first device of a first combination of devices corresponding to a first network topology;
cause the first device to process first data with a first portion of the NN; and
cause a second device of a second combination of devices to process second data with a second portion of the NN, the second combination of devices corresponding to a second network topology.

14. The non-transitory storage medium of claim 13, wherein the first combination of devices is different from the second combination of devices.

15. The non-transitory storage medium of claim 13, wherein the programmable circuitry is to, in response to completion of the first device processing the first data with the first portion of the NN, cause a determination that the first combination of devices is different from the second combination of devices.

16. The non-transitory storage medium of claim 13, wherein the programmable circuitry is to cause a determination that the first network topology is different from the second network topology.

17.-22. (canceled)

23. An apparatus comprising:
neural network (NN) transceiver circuitry to:
identify a neural network to a first device of a first combination of devices corresponding to a first network topology; and
network interface circuitry to:
cause the first device to process first data with a first portion of the NN; and
cause a second device of a second combination of devices to process second data with a second portion of the NN, the second combination of devices corresponding to a second network topology.

24. The apparatus of claim 23, wherein the first combination of devices is different from the second combination of devices.

25. The apparatus of claim 23, further including network topology circuitry, the network topology circuitry to, in response to completion of the first device processing the first data with the first portion of the NN, cause a determination that the first combination of devices is different from the second combination of devices.

26. The apparatus of claim 25, wherein the network topology circuitry is to cause a determination that the first network topology is different from the second network topology.

27.-69. (canceled)
